(19) United States
(12) Patent Application Publication
(10) Pub. No.: US 2025/0267030 A1
(43) Pub. Date: Aug. 21, 2025

(54) SMART HUB WITH UNICAST AND MULTICAST SUPPORT

(71) Applicant: EDST, LLC, Lubbock, TX (US)

(72) Inventors: Tray Johnson, Lubbock, TX (US); Clinton A. Branch, Lubbock, TX (US)

(21) Appl. No.: 18/444,089

(22) Filed: Feb. 16, 2024

(51) Int. Cl. H04L 12/28; G06Q 50/163; H04W 4/06

(52) U.S. Cl. CPC H04L 12/2816; G06Q 50/163; H04W 4/06

(57) ABSTRACT

Systems and methods for managing or controlling smart devices are disclosed. Multicast configuration information is generated for a multicast group including a plurality of smart hubs. Each smart hub includes a plurality of communication interfaces. The multicast configuration information is transmitted via a first communication channel of a wireless network to respective first communication interfaces of the smart hubs to configure respective second communication interfaces of the smart hubs to receive multicast group communications via a second communication channel of the wireless network. Multicast session information indicating a specified time for the multicast group to receive the multicast communications during a multicast session is transmitted to the respective first communication interfaces of the smart hubs. Multicast message(s) are transmitted to the multicast group at the specified time of the multicast session via the second communication channel.

### TECHNICAL FIELD

The present disclosure is directed to an intelligent hub device. In particular, the present disclosure is directed to an intelligent hub having multi-band/multi-radio communication capabilities, long range network backhaul capabilities, unicast and multicast transmission capabilities, and that can be implemented in a system for controlling and securing smart door locks and other smart devices.

### BACKGROUND

Technology and the benefits it provides often plays an important role with respect to how many consumers make decisions. This has become increasingly so in the real-estate industry, and more specifically in the multi-family residential property market. To illustrate, Class A multi-family residential properties (e.g., apartments, etc.) may have keyless entry systems installed that allow residents to gain entry into their respective apartments by placing a key fob (or “fob”), smartphone, or smartcard in proximity to a door lock. As another example, these Class A multi-family residential properties may have been constructed with infrastructure, such as Wireless Fidelity (Wi-Fi) access points and/or wired networks (e.g., Ethernet), for providing Internet access to residents. While the security and convenience these technologies provide are attractive to residents, deploying such technologies in older multi-family residential properties, such as Class B and C multi-family residential properties, can be cost prohibitive and/or present challenges with respect to the security of residents of such properties.

For example, keyless entry systems may utilize various types of smart door locks. Such a smart door lock may be controlled (e.g., locked and unlocked) remotely through an Internet-accessible network connection and/or locally by a device (e.g., a fob, smartphone, smartcard, etc.) that is placed in proximity to a sensor of the door lock. The cost to deploy a smart door lock-based keyless entry system in a multi-family residential property can be significant due to the requirement that a local area network (LAN) communication infrastructure (e.g., a property-wide mesh network, a Wi-Fi network, etc.) be provided to facilitate network-based control of the door lock. Such costs and challenges can also apply to installing other types of smart devices at a multi-family residential property.

Security and reliability are also issues that have slowed the deployment and integration of smart devices in multi-family residential properties. To illustrate, a property manager or owner may decide to install a set of smart devices in each unit of a multi-family residential property, such as a smart thermostat, a smart door lock, and one or more smart lights. Although these smart devices may be intended to remain a part of the unit after a resident moves out, if the resident is able to access and control the smart devices, they may steal the smart devices or tamper with or damage the smart devices prior to moving out. One way to prevent this outcome, or reduce its likelihood, is for the property manager to have complete control of the smart devices. However, this may be inconvenient for the resident who may wish to control the lights or unlock the door without having to call the property manager each time. Therefore, the property manager may provide an application to enable the resident to control certain aspects of the smart devices. The property manager, however, would still be responsible for maintaining the smart devices while the resident resides in the unit and reconfiguring the smart devices with new access credentials after the resident moves out. Thus, the property manager may have to periodically send an employee to physically access the smart devices to manually reconfigure access credentials or perform maintenance operations, such as installing firmware updates. As the smart devices of a multi-family residential property may be installed across multiple units in different buildings on the property, having to manually reconfigure and/or update individual devices can be a very time-consuming and inefficient process.

Remote property management solutions may be available for the property manager to remotely manage and control the smart devices over a wireless network without needing to physically access the devices. Such a wireless solution may enable the property manager to send administrative level commands to the individual devices for purposes of configuring access credentials and/or installing periodic firmware updates. However, given the multitude of smart devices that may installed across the various units and buildings of a multi-family residential property, the process of remotely managing and controlling these devices on an individual basis is not only administratively burdensome and time consuming, it can also reduce network performance and the amount of bandwidth available for other communications.

### SUMMARY

Embodiments described herein provide a system that comprises smart hubs, such as smart thermostat hubs, and a server for controlling and configuring smart devices. In some embodiments, a smart thermostat hub (or “smart hub”) may include various communication interfaces to facilitate bi-directional communications between the smart hub and other devices over various communication networks, including different types of wireless networks. For example, the smart hub may include a first communication interface for communicating with the server over a first communication channel between the smart hub and the server via a first wireless network. The smart hub may also include a second communication interface for communicating with the server over a second communication channel between the smart hub and the server via the first wireless network. The first wireless network may be, for example, a long-range wireless network, such as a cellular network or a low-power wide area network (LPWAN). The smart hub may further include a third communication interface for communicating with one or more smart devices (e.g., a smart thermostat, smart door locks, smart lights, wireless cameras, security devices, smart TVs, smart speakers, entertainment devices, etc.) via a second wireless network. In some implementations, the server may be associated with a property management platform of a commercial property, where a different smart hub and corresponding smart devices may be associated with each unit or tenant of the commercial property. The commercial property may include any of various commercial properties that serve residential, commercial, or industrial tenants. Such properties may include apartment buildings, strip malls, warehouses, etc., as illustrative, non-limiting examples. In a particular implementation, the server is associated with a property management platform of a multi-family residential property, and a smart hub and a corresponding smart device(s) are associated with one or more units of the multi-family residential property.

In some cases, the smart device(s) may be located (or installed) in the same unit as the smart hub. Alternatively, the smart device(s) may be located in a different unit (e.g., a neighboring unit) of the multi-family residential property and assigned (or reassigned) to the smart hub (e.g., due to a malfunction associated with another smart hub in the neighboring unit). The second wireless network may be, for example, a short-range wireless network, such as a Bluetooth network, a Z-Wave network, a Zigbee network, a Thread-compliant network, a Matter-compliant network, or a Wi-Fi network, through which the smart device(s) may be communicatively coupled to the smart hub (or third communication interface thereof), e.g., via one or more short-range wireless communication links or channels between the smart hub and the smart device(s).

In some embodiments, the first communication interface of the smart hub may be a first radio configured to receive unicast communications sent by the server via the first communication channel of the long-range wireless network to a unique unicast address associated with the first radio. The second communication interface of the smart hub may be a second radio configured to receive multicast communications sent by the server via the second communication channel of the long-range wireless network to a multicast group address associated with a multicast group. In addition to the smart hub (or second radio thereof), the multicast group may include, for example, other smart hubs (e.g., smart hubs associated with other units of a multi-family residential property). Each smart hub or member of the multicast group in this example may include similar first and second communication interfaces (or radios) configured to receive unicast and multicast communications from the server via respective first and second communication channels of the long-range wireless network. Accordingly, the first communication channel may serve as a dedicated unicast communication channel between the server and the first communication interface (or first radio) of each smart hub over the long-range wireless network. The second communication channel may serve as a dedicated multicast communication channel between the server and the second communication interface (or second radio) of each smart hub of the multicast group over the long-range wireless network. Each smart hub of the multicast group may also include a third communication interface configured to communicate with one or more smart devices (e.g., for a corresponding unit of the multi-family residential property, as discussed above).

In some embodiments, the server may use the first communication channel (or dedicated unicast communication channel) to send multicast configuration information to the first communication interface of each smart hub for configuring the respective second communication interface of each smart hub to receive multicast communications directed to a multicast group that includes the smart hubs. The multicast communications may include various multicast messages or downlink frames sent by the server to the multicast group via the second communication channel (or dedicated multicast communication channel) of the long-range wireless network (e.g., LPWAN). Such multicast messages may include, for example, one or more multicast commands relating to the setup and management of the multicast group and/or a multicast session for scheduling communications to or from the multicast group members (e.g., various smart hubs corresponding to different units of the multi-family residential property).

In some implementations, the multicast configuration information may be included in a first command received from the server via a first communication interface of a smart hub to configure the second communication interface of the smart hub to receive multicast messages from the server over the second communication channel of the LPWAN during one or more multicast sessions. For example, the configuration information may include one or more parameters of the second communication channel, one or more timing parameters associated with multicast messages, a multicast group address for use in decoding multicast messages, other information, or a combination thereof. After receiving the multicast configuration information, the smart hub may configure the second communication interface accordingly and participate in multicast sessions between the server and a multicast group. For example, each smart hub in the multicast group may receive, over the second communication channel, a first multicast message from the server at a respective second communication interface. In some implementations, the first multicast message may include control information for one or more smart devices associated with a corresponding unit of a multi-family residential property, a firmware update, property manager access credentials, or the like. For example, the server may send control information for setting the lights of all vacant units to operate on a particular schedule via a multicast message to the multicast group. The smart hub in this example may transmit, to the one or more smart devices via the third communication interface for the second wireless network, one or more commands to control an operating state of the one or more smart devices in accordance with the control information included in the first multicast message. For example, a smart hub that receives the first multicast message may transmit a command to turn on or turn off a smart light via a Bluetooth network or other short range network, or may transmit scheduling information to set operation of the smart light according to a schedule.

In some embodiments, the server may use the second communication channel (or dedicated multicast communication channel) between the server and the multicast communication interface of each of a plurality of smart hubs in a multicast group to transmit one or more multicast messages (or multicast downlink frames) including commands for controlling or configuring either the one or more smart devices associated with the smart hub or the smart hub itself. For example, a multicast message sent by the server to the multicast group during a multicast session may include control information that each smart hub may use to control an operating state of corresponding smart devices (e.g., a lock state of a smart door lock) associated with that smart hub. Additionally or alternatively, the server may broadcast a multicast message to the multicast group that includes information for updating a configuration or firmware of each smart hub. The firmware may be stored in a non-volatile memory of each smart hub and may be executable by a processor of the smart hub. By leveraging both unicast and multicast backhaul messaging in the context of a multi-family residential property, for example, smart hubs may be installed in units of a multi-family residential property and be controlled both individually and as a group by a property management platform, thereby enabling more efficient communications that reduces network congestion in addition to less complicated and easier installation of smart device support to both new and existing multi-family residential properties.

In a particular aspect, a system for controlling smart devices is disclosed. The system includes: a first communication interface to communicate with a server via a first communication channel of a first wireless network; a second communication interface to communicate with the server via a second communication channel of the first wireless network; and a third communication interface to communicate with one or more smart devices via a second wireless network. The system further includes a processor and a memory coupled to the processor. The memory stores instructions, which, when executed by the processor, cause the processor to execute operations to: receive, from the server via the first communication interface, multicast configuration information for a multicast group; configure the second communication interface to receive multicast messages from the server via the second communication channel in accordance with the multicast configuration information; receive, from the server via the second communication interface, a first multicast message directed to the multicast group, the first multicast message including control information for the one or more smart devices; and transmit, to the one or more smart devices via the third communication interface, one or more commands to control an operating state of the one or more smart devices in accordance with the control information included in the first multicast message.

In another particular aspect, a system is disclosed. The system includes a processor and a memory coupled to the processor. The memory stores instructions, which, when executed by the processor, cause the processor to execute operations to: generate multicast configuration information for a multicast group, the multicast group including a plurality of smart hubs, and each smart hub of the plurality of smart hubs including a plurality of communication interfaces; transmit, to respective first communication interfaces of the plurality of smart hubs via respective first communication channels of a wireless network, the multicast configuration information to configure respective second communication interfaces of the plurality of smart hubs to receive multicast communications directed to the multicast group via a second communication channel of the wireless network; transmit, to the respective first communication interfaces of the plurality of smart hubs via the respective first communication channels, multicast session information indicating a specified time for the multicast group to receive the multicast communications during a multicast session over the second communication channel; and transmit, to the multicast group via the second communication channel, one or more multicast messages at the specified time of the multicast session.

In yet another particular aspect, a method for configuring smart devices is disclosed. The method includes generating, by a server, multicast configuration information for a multicast group, the multicast group including a plurality of smart hubs, and each smart hub of the plurality of smart hubs including a plurality of communication interfaces. The method also includes transmitting, by the server to respective first communication interfaces of the plurality of smart hubs via respective first communication channels of a wireless network, the multicast configuration information to configure respective second communication interfaces of the plurality of smart hubs to receive multicast communications directed to the multicast group via a second communication channel of the wireless network. The method includes transmitting, by the server to the respective first communication interfaces of the plurality of smart hubs via the respective first communication channels, multicast session information indicating a specified time for the multicast group to receive the multicast communications during a multicast session over the second communication channel. The method further includes transmitting, by the server to the multicast group via the second communication channel, one or more multicast messages at the specified time of the multicast session.

In yet another particular aspect, a method is disclosed. The method includes receiving, at a first communication interface of a smart hub from a server via a first communication channel of a first wireless network, multicast configuration information for a multicast group. The method also includes configuring, by the smart hub, a second communication interface of the smart hub to receive multicast messages from the server via a second communication channel of the first wireless network in accordance with the multicast configuration information. The method includes receiving, at the second communication interface from the server via the second communication channel, a first multicast message directed to the multicast group, the first multicast message including control information for one or more smart devices. The method further includes transmitting, from a third communication interface of the smart hub to the one or more smart devices via a second wireless network, one or more commands to control an operating state of the one or more smart devices in accordance with the control information included in the first multicast message.

The foregoing has outlined rather broadly the features and technical advantages of the present invention in order that the detailed description of the invention that follows may be better understood. Additional features and advantages of the invention will be described hereinafter which form the subject of the claims of the invention. While the disclosed embodiments are described in the context of a multi-family residential property and associated management platform, it should be appreciated that embodiments are not intended to be limited thereto and that the disclosed messaging techniques for controlling smart devices may be applied to any of various commercial contexts, such as smart retail, smart agriculture, smart healthcare, smart parking, smart supply chain, smart city, and smart industrial applications. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 is a block diagram of a system for securely managing smart devices within a multi-family residential property in accordance with embodiments of the present disclosure;

FIG. 2 is a block diagram of a smart thermostat hub in accordance with embodiments of the present disclosure;

FIG. 3 is a block diagram of a smart hub in accordance with embodiments of the present disclosure;

FIG. 4 is a block diagram of a modular smart thermostat hub in accordance with embodiments of the present disclosure;

FIG. 5 is a block diagram illustrating aspects of an intelligent property management system configured in accordance with embodiments of the present disclosure;

FIG. 6 is a block diagram illustrating additional aspects of an intelligent property management system configured in accordance with embodiments of the present disclosure;

FIG. 7 is a block diagram illustrating additional aspects of an intelligent property management system configured in accordance with embodiments of the present disclosure;

FIG. 8 is a flow diagram illustrating an exemplary method for securing smart devices within an apartment of a multi-family residential property in accordance with embodiments of the present disclosure;

FIG. 9 is a flow diagram of an exemplary method for retrieving access log data from a smart door lock in accordance with embodiments of the present disclosure;

FIG. 10 is a flow diagram illustrating an exemplary method for securing a smart door lock of an apartment of a multi-family residential property in accordance with embodiments of the present disclosure;

FIG. 11 is a flow diagram illustrating another exemplary method for securing a smart door lock of an apartment of a multi-family residential property in accordance with embodiments of the present disclosure;

FIG. 12 is a block diagram illustrating exemplary features of a smart door lock configured in accordance with embodiments of the present disclosure;

FIG. 13 is a block diagram illustrating an embodiment of a smart thermostat in accordance with embodiments of the present disclosure;

FIG. 14 is a block diagram of a system for managing and controlling smart devices associated with a unit of a multi-family residential property over one or more wireless networks in accordance with embodiments of the present disclosure;

FIG. 15 is a block diagram of a system for configuring smart hubs of a multi-family residential property using dedicated unicast and multicast communication channels between each smart hub and a server of a property management platform in accordance with embodiments of the present disclosure;

FIG. 16 is an exemplary graphical user interface (GUI) of a mobile application for providing smart device access control features and network configuration features to a mobile device user in accordance with embodiments of the present disclosure;

FIG. 17 is an exemplary GUI of a property management application for providing smart device access control features, credential management features for smart locks, and/or device reconfiguration features to a property management platform user in accordance with embodiments of the present disclosure;

FIG. 18 is an exemplary GUI of a multicast configuration dashboard for configuring a multicast group including smart hubs of a multi-family residential property via an application of a property management platform in accordance with embodiments of the present disclosure;

FIG. 19 is a flowchart of an exemplary process for configuring smart hubs of a property to support unicast and multicast communications over dedicated unicast and multicast communication channels of a wireless network in accordance with embodiments of the present disclosure; and

FIG. 20 is a flowchart of an exemplary process for controlling smart devices in a unit of a property using a smart hub with support for unicast and multicast communications over dedicated unicast and multicast communication channels of a wireless network in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

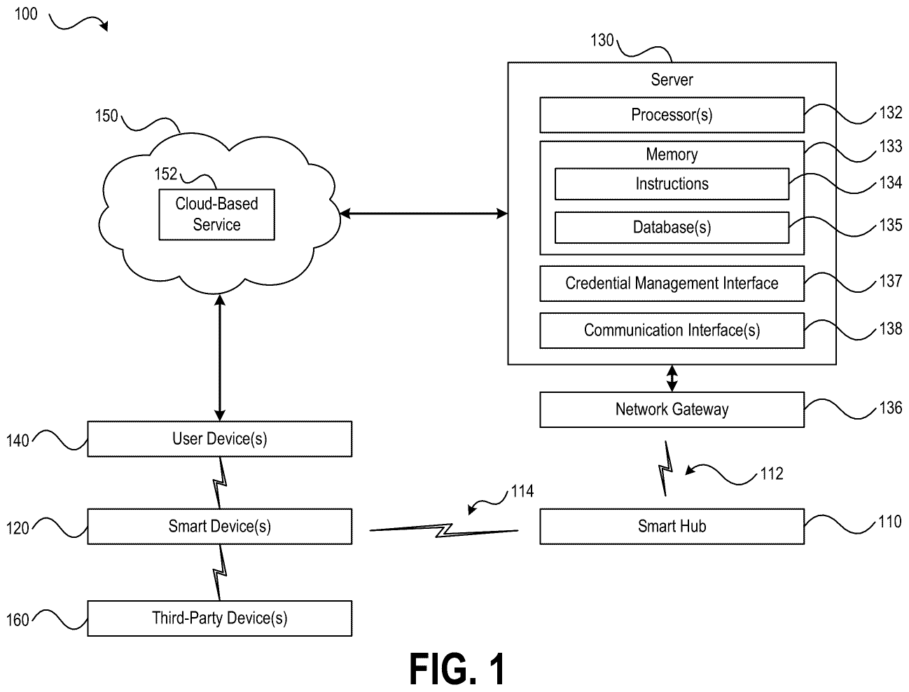

FIG. 1 is a block diagram of an exemplary system 100 for securely managing smart devices of a multi-family residential property in accordance with embodiments of the present disclosure. In some embodiments, system 100 may be used to implement a property management platform that provides various improvements over conventional property management solutions for the management and control of smart devices associated with different units of a multi-family residential property. Each unit of the multi-family residential property may be associated with a smart hub (e.g., a smart hub 110) that is configured to control smart devices installed in the unit based on control information provided by a server of the property management platform (e.g., a server 130 of system 100). The smart hub associated with each unit may include a plurality of communication interfaces (e.g., wireless radios) for communicating with the server over corresponding communication channels of a long-range wireless network. For example, a first communication interface of the smart hub may be configured to receive unicast communications sent by the server to a unique unicast address associated with the first communication interface via a first communication channel (e.g., a dedicated unicast channel) of the long-range wireless network. In some embodiments, the server may use the first communication interface of the smart hub to configure a second communication interface of the smart hub for multicast communications over a dedicated multicast communication channel between the second communication interface and the server over the long-range wireless network. The second communication interface of the smart hub may be configured to receive multicast communications sent by the server to a multicast group address associated with a multicast group via a second communication channel (e.g., a dedicated multicast channel) of the long-range wireless network. Although described as distinct communication interfaces or wireless radios, in other implementations, a single communication interface may be configured to communicate via different channels of different wireless networks to perform the operations described herein.

As will be described in more detail below, having support for both unicast and multicast communications between the server and each of the smart hubs of a multi-family residential property provides an efficient way for a property manager to use the property management platform of system 100 to simultaneously control or configure multiple smart hubs and other smart devices by sending a single multicast message (or downlink frame) rather than having to send multiple messages in a serial manner to the individual devices. This not only saves a significant amount of time, it also reduces communication bandwidth and improves network performance. Additionally, in some implementations that use a low-power, wide area network (LPWAN) connection instead of a Wi-Fi connection for backhaul communications between the smart hubs and the server, system 100 may reduce the cost of deploying various technologies in a multi-family residential property, thereby enabling such technologies to be utilized in certain multi-family residential properties for which previous technologies were deemed cost prohibitive, such as technologies used in Class B and Class C properties, which may be combined with existing technologies at Class A properties.

As shown in FIG. 1, system 100 may include a smart hub 110, one or more smart devices 120, and a server 130. Although only smart hub 110 is shown in FIG. 1, it should be appreciated that system 100 may include any number of smart hubs. For example, smart hub 110 may be one of a plurality of smart hubs corresponding to different units of the multi-family residential property, as described above. Server 130 may include one or more processors 132, a memory 133, a credential management interface 137, and one or more communication interfaces 138. Memory 133 may include random access memory (RAM), read only memory (ROM), hard disk drives(s) (HDDs), solid state drive(s) (SSDs), network attached storage (NAS) devices, or other types of memory devices for storing data in a persistent or non-persistent state. Memory 133 may store instructions 134 that, when executed by the one or more processors 132, cause the one or more processors 132 to perform the operations of server 130, including operations for managing and securing access credentials for the multi-family residential property, as will be described in further detail below. Additionally, one or more databases 135 may be stored at memory 133. Exemplary types of information that may be stored at the one or more databases 135 are described in more detail below. It is noted that although FIG. 1 illustrates server 130 as a standalone device, it is to be understood that server 130 and the functionality described herein with respect to the server 130, may be implemented using more than one server or via a collection of computing resources (e.g., processors, memory, communication interfaces, and the like) deployed in the cloud.

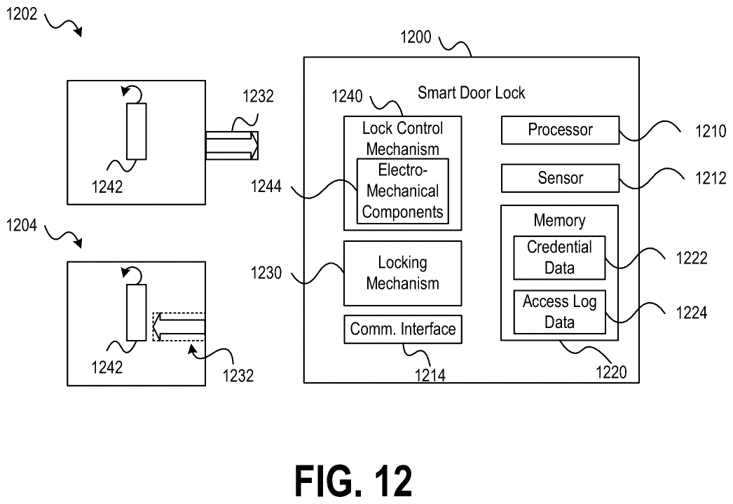

Credential management interface 137 may be configured to manage (e.g., create and disable) access credentials provided to residents of a multi-family residential property. For example, credential management interface 137 may be configured to generate access credentials that enable a resident to access one or more residential units of a multi-family residential property. Such a unit may correspond to, for example, the individual resident's apartment unit or a designated common area, such as a workout facility, a pool, a parking garage, a lounge, a conference room, a laundry room, a vending machine room, a lobby, an elevator, and the like, within the multi-family residential property. Access credentials may be stored on a device, such as a key fob, a smartcard, or a resident's smartphone, which may be used to control (e.g., lock and unlock) a smart door lock installed on a door of the unit. In an embodiment, each of the smart door locks of the multi-family residential property may comprise logic configured to process access credentials presented for authentication. For example, when a resident places a device having the resident's access credential in proximity to a sensor (e.g., a near field communication (NFC) device, a Bluetooth device, etc.) of the smart door lock, access credential may be received by the logic for processing, which may include applying a hash function or other data processing technique. If the processing is successful (e.g., a result of the hash function or other processing technique satisfies a criterion), a lock control mechanism may be engaged, thereby enabling the resident to turn a knob that controls a deadbolt or other form of locking device (e.g., a mortise lock, a tubular lock, etc.) to either lock or unlock the smart door lock. If the processing is not successful (e.g., the result of the hash function or other processing technique does not satisfy the criterion), the lock control mechanism may not be engaged. When the lock control mechanism is not engaged, the knob that controls the deadbolt may spin freely (or not move at all), thereby preventing the deadbolt from being placed in a locked state or an unlocked state. Other types of locking devices may be similarly engaged or disengaged by an appropriate lock control mechanism based on the processing. Additional features provided by the smart door lock in accordance with embodiments are described in more detail below with respect to FIG. 12.

In an embodiment, rather than generating access credentials, the credential management interface 137 may interface (e.g., via a network 150) with a system of a third-party service provider of a cloud-based service 152 that is configured to generate access credentials. In such an embodiment, the credential management interface 137 may enable property management personnel and/or a resident to request that an additional access credential, which may be utilized to unlock the smart door lock, be generated by cloud-based service 152. As a result of the request, cloud-based service 152 may generate the requested access credential (assuming appropriate authentication of the request and/or requestor has been performed). Where the access credential is to be utilized by one or more user devices 140, such as a smart phone, cloud-based service 152 may provide the newly generated access credential to the user device directly, such as by downloading the access credential to the user device 140 via an access credential management application installed on the user device 140, or indirectly, such via a message (e.g., a text message, e-mail message, etc.) provided to the user device 140 that includes information that enables the user device 140 to retrieve or otherwise obtain or download the newly generated access credential, or via another technique. In an embodiment, if an access credential that is to be disabled corresponds to an access credential that was generated by cloud-based service 152 and that is stored on the user device 140, the server 130 may be configured to interact with the cloud-based service 152 to disable such access credentials, such as by providing information to the user device 140 to disable further use of the access credential. If, however, the access credential is stored on one or more third-party device(s) 160, such as one or more key fobs or smartcards, disabling of the access credential may be accomplished via communication of control information to smart hub 110, as will be described in more detail below.

In an embodiment, one or more databases 135 may include a credential database storing information associated with smart door locks installed at the multi-family residential property. When an access credential for a particular smart door lock is to be generated, credential management interface 137 may access the credential database to obtain information associated with the particular smart door lock, and then use the obtained information to create access credentials. For example, the information stored in access credential database 135 may comprise information that may be used to generate access credentials that, when processed by the logic of the designated smart door lock, produce a successful result. Additionally, when new access credentials are generated, access credential management interface 137 may update one or more records stored at the credential database (or another database), for example, to record information that identifies the resident or individual for whom the access credentials were generated.

The one or more communication interfaces 138 may communicatively couple server 130 to smart hubs, such as smart hub 110, deployed within the multi-family residential property via one or more communication networks. For example, a first communication interface of server 130 may be configured to communicate with smart hub 110 via a communication link 112 over a long-range wireless network, such as a cellular network, a low-power, wide area network (LPWAN), or a Long Range (LoRa) wide area network (LoRaWAN). A second communication interface of server 130 may be configured to communicate with the one or more communication networks via a short-range wireless network or non-LPWAN communication link, such as an Institute of Electrical and Electronics Engineers (IEEE) 802.11 communication link, an Ethernet communication link, and the like. In some embodiments, communication link 112 may include or correspond to one or more communication channels or communication links between server 130 and smart hub 110 over the long-range wireless network. For example, the communication channels/links corresponding to communication link 112 may be implemented as LPWAN communication links, LoRaWAN communication links, narrowband—Internet of Things (NB-IoT) communication links, Sigfox-based communication links, Weightless communication links, DASH7 communication links, Wize communication links, chirp spread spectrum (CSS)-based communication links, MIoTy communication links, IEEE 802.11ah communication links, or any other low-power, long-range communication links. In some other implementations, the communication channels/links corresponding to communication link 112 may be implemented as wide area network (WAN) communication links, such as Wi-Fi communication links or other non-low-power WAN communication links, although such implementations may have higher costs and complexity as compared to LPWAN implementations.

Alternatively, the communication link 112 may include or correspond to communication channels or links between server 130 and smart hub 110 over a cellular network. Examples of such a cellular network include, but are not limited to, a Global System for Mobile Communications (GSM) network, a General Packet Radio Service (GPRS) network, a Code-Division Multiple Access (CDMA) network, a Frequency-Division Multiple Access (FDMA) network, an Orthogonal Frequency-Division Multiple Access (OFDMA) network, and a Space-Division Multiple Access (SDMA) network. Such a cellular network may support any of various cellular communication standards and technologies including, but are not limited to, 3G, 4G, Long Term Evolution (LTE), 5G, and new technologies being developed, such as 6G. In some implementations, communication link 112 may utilize communication links that support a low-power cellular communications protocol, such as Long-Term Evolution for Machines (LTE-M) or Long-Term Evolution Type Communication (LTE-MTC) communication links.

In some embodiments, the first communication interface of server 130 may communicatively couple the server 130 to an appropriate network gateway 136, as shown in FIG. 1. Network gateway 136 may be configured to relay information received from server 130 to smart hub 110 and other smart hubs of a multi-family residential property via the communication link 112 (e.g., one or more communication channels) between the first communication interface and a corresponding interface of each smart hub. As described above, the communication link 112 in some implementations may be a communication link within a LPWAN or a cellular network. In some such implementations, network gateway 136 may include or be integrated in, or replaced by, one or more other components of a LPWAN or cellular network.

In some embodiments, network gateway 136 may support both unicast and multicast communications between server 130 and smart hub 110 (and other smart hubs of the multi-family residential property). In some embodiments, smart hub 110 may include a plurality of communication interfaces for receiving unicast and multicast communications from server 130 and/or gateway 136 via corresponding unicast and multicast communication channels. In some implementations, the communication interfaces may communicatively couple smart hub 110 to server 130 via communication link 112. Communication link 112 may represent, for example, a plurality of communication channels over a long-range wireless network, such as a LPWAN, cellular network, or other long-range communication network. In some embodiments, the communication channels over the long-range wireless network may include a first communication channel dedicated to unicast communications between server 130 and a first communication interface of smart hub 110 and a second communication channel dedicated to multicast communications between server 130 and a second communication interface of smart hub 110. Similar unicast and multicast communication channels may exist between server 130 and corresponding interfaces of other smart hubs of the multi-family residential property. In some embodiments, server 130 may use the first communication interface of smart hub 110 to configure the second communication interface of smart hub 110 for multicast communications directed to a multicast group. The multicast group may include smart hub 110 and other smart hubs corresponding to other units of the multi-family residential property, as will be described in further detail below.

In some embodiments, network gateway 136 may treat the radios (or unicast and multicast communication interfaces) of smart hub 110 as separate subnets or segments of the long-range wireless network. Network gateway 136 may connect these subnets or segments together, enabling communication between devices in the different subnets. Accordingly, network gateway 136 may be responsible for routing traffic between the unicast and multicast subnets as necessary. Network gateway 136 may also be responsible for performing any unicast-to-multicast conversion or multicast-to-unicast conversion. Network gateway 136 may maintain routing tables for forwarding data packets between the subnets based on the destination address of each packet. For example, each packet may be addressed to either a unique unicast address associated with a first communication interface of smart hub 110 or a multicast group address associated with a second communication interface of smart hub 110 and other devices in a multicast group, as will be described in further detail below.

In addition to the first and second communication interfaces, smart hub 110 may include one or more additional communication interfaces (e.g., a third communication interface) that communicatively couples smart hub 110 to smart device(s) 120 via one or more communication links 114, e.g., one or more communication channels over a short-range wireless network. Examples of such a short-range wireless network include, but are not limited to, a wireless personal area network (WPAN), a Wi-Fi communication network, a Zigbee communication network, a Bluetooth communication network (e.g., a standard Bluetooth communication network or a Bluetooth Low Energy (BLE) communication network), a Z-Wave communication network, a Matter-compliant communication network, a Thread-compliant communication network, and the like, associated with a unit of the multi-family residential property. As referred to herein, Matter includes a wireless platform along with a set of wireless communication standard(s) and/or protocol(s) that focus on supporting a unified IoT ecosystem using internet protocol (IP)-based communications. As referred to herein, Thread is an IP-based wireless communication protocol for mesh networking. As will be described in more detail below, smart hub 110 may be deployed within any designated area or unit of a multi-family residential property, such as an individual apartment or residential unit, or a designated common area, such as a gym, a game room, etc., and may be utilized to facilitate remote access to, and control of, smart devices in proximity to smart hub 110.

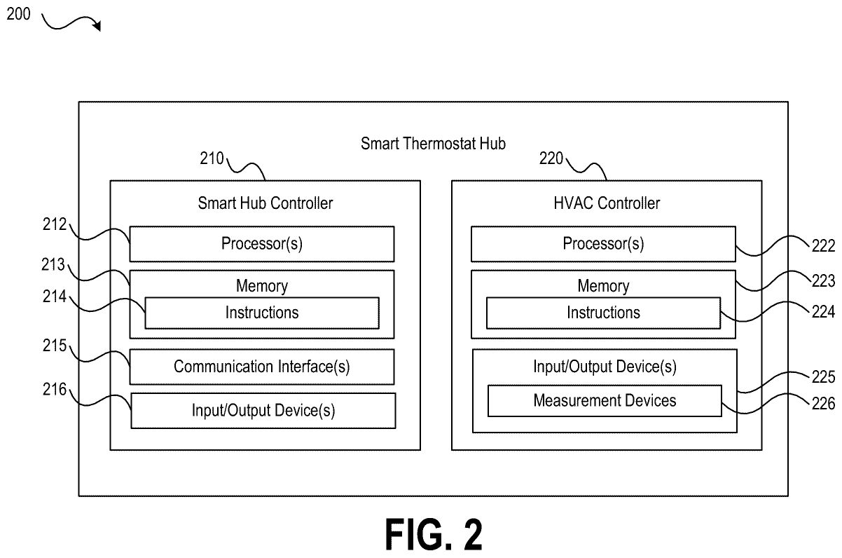

In some embodiments, smart hub 110 may be a smart thermostat hub. For example, in FIG. 2, a block diagram of a smart thermostat hub 200 in accordance with embodiments of the present disclosure is shown. As shown in FIG. 2, smart thermostat hub 200 includes a smart hub controller 210 and a heating, ventilation, and air conditioning (HVAC) controller 220. Smart hub controller 210 may include one or more processors 212, a memory 213, communication interfaces 215, and one or more input/output (I/O) devices 216. Memory 213 may include RAM, ROM, one or more HDDs, one or more SSDs, or other types of memory devices for storing data in a persistent or non-persistent state. Memory 213 may store instructions 214 that, when executed by the one or more processors 212, cause the one or more processors 212 to perform operations of smart hub 110 and other smart hub devices, as will be described in further detail below. As explained above with reference to smart hub 110 of FIG. 1, communication interfaces 215 may include a plurality of communication interfaces configured to communicatively couple smart hub controller 210 to a remote server (e.g., server 130 of FIG. 1) via corresponding communication channels (e.g., communication link 112 of FIG. 1) of a long-range wireless network and one or more additional communication interfaces configured to communicatively couple smart hub controller 210 to one or more smart devices (e.g., the one or more smart devices 120 of FIG. 1) via one or more communication channels (e.g., communication links 114 of FIG. 1) of a short-range wireless network, e.g., a Wi-Fi network, a Zigbee network, a Z-Wave network, a Bluetooth network, or other short-range communication network.

The one or more I/O devices 216 may be configured to facilitate user interaction with smart hub controller 210. For example, a user (e.g., employee, contractor, or agent of the multi-family residential property) may periodically couple an external device (e.g., third-party device(s) 160 of FIG. 1) to smart hub controller 210 to perform software upgrades, diagnostics, etc. It is noted, however, that the communication link between smart hub controller 210 and a server (e.g., server 130 of FIG. 1) of a property management platform associated with the multi-family residential property may be utilized for these purposes in some embodiments. The one or more I/O devices 216 may include a USB interface, a serial port interface, or other type of wired or wireless interface suitable for exchanging information with, obtaining information from, or providing information to smart hub control 210. Additionally, I/O device(s) 216 may include a display device, which may provide information regarding an operational status of smart hub controller 210. For example, the display device may present information associated with a status of various communication links between smart hub controller 210 and smart devices and/or the remote server. It is noted that the specific I/O devices described above have been provided for purposes of illustration, rather than by way of limitation and that I/O device(s) 216 may include other types of I/O devices that facilitate interaction with smart hub controller 210.

As shown in FIG. 2, HVAC controller 220 may include one or more processors 222, a memory 223, and one or more I/O devices 225. Memory 223 may include RAM, ROM, one or more HDDs, one or more SSDs, or other types of memory devices for storing data in a persistent or non-persistent state. Memory 223 may store instructions 224 that, when executed by the one or more processors 222, cause the one or more processors 222 to perform operations for modifying an ambient setting of an environment, such as heating or cooling an apartment of a multi-family residential property to a desired temperature. One or more I/O devices 225 may include buttons, display devices, a touch screen, speakers, microphones, and/or other devices that facilitate interaction with HVAC controller 220. For example, a user may interact with the one or more I/O devices 225 to adjust a temperature of the thermostat. In response to such interaction, HVAC controller 220 may initiate operations to heat or cool an ambient environment specified by the user interaction. As shown in FIG. 2, one or more I/O devices 225 may also include measurement devices 226, such as a temperature sensor, which may be used to determine whether the temperature of the ambient environment is within a threshold tolerance (e.g., 0.5 degree, 1 degree, 2 degrees, etc.) of the target temperature specified by the user interaction. It should be appreciated that measurement devices 226 may include any number of sensors or devices for measuring and recording any of various types of measurements, as desired for a particular implementation.

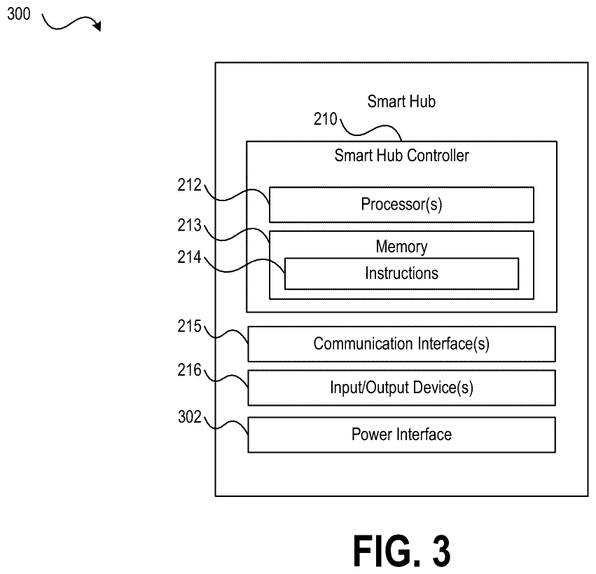

Referring to FIG. 3, a block diagram of another smart hub in accordance with embodiments of the present disclosure is shown as a smart hub 300. Like smart thermostat hub 200 of FIG. 2 described above, smart hub 300 of FIG. 3 includes smart hub controller 210, one or more processors 212, memory 213, instructions 214, communication interfaces 215, and I/O device(s) 216. However, unlike smart thermostat hub 200, smart hub 300 also includes a power interface 302. Power interface 302 may comprise one or more components (e.g., a plug configured to interface with a power outlet, a power coupling configured to couple smart hub 300 to a power source via electrical wiring of a structure, a battery interface, and the like) configured to provide operational power to smart hub 300. Therefore, as compared to smart thermostat hub 200 of FIG. 2, smart hub 300 of FIG. 3 illustrates an embodiment of smart hub 110 of FIG. 1 as a standalone device.

It is noted that, as compared to smart hub 300 of FIG. 3, smart thermostat hub 200 of FIG. 2 may provide several advantages for multi-family residential properties, such as Class B and C properties in particular. For example, a common problem when deploying new technologies in Class B and C properties is the lack of necessary infrastructure needed to support the new technology. To install the standalone smart hub 300 illustrated in FIG. 3, an electrician would need to find or create a suitable source for tapping into existing electrical wiring of an apartment in order to hard wire smart hub 300 into the apartment's electrical power infrastructure. This may include hardwiring smart hub 300 to electrical wiring of a power outlet, which would result in loss of an existing power outlet of the apartment. Alternatively, an electrician may install smart hub 300 on a wall of the apartment by tapping into or splicing the existing electrical wiring of the apartment, but this option would create a significant cost if performed for many apartments of a multi-family residential property. An additional option would be to plug smart hub 300 into an electrical outlet of the apartment. This option may be problematic as the resident could easily unplug smart hub 300 from the electrical outlet, thereby preventing operation of smart hub 300 and the various features it provides with respect to certain smart devices of the apartment, such as managing and controlling a smart door lock and enhanced property management functionalities (e.g., controlling a thermostat, light fixtures, etc.).

In contrast, smart thermostat hub 200 of FIG. 2 is designed to be installed as a replacement to existing thermostats that may be present in a multi-family residential property. Even for Class B and Class C residential properties, the existing thermostats would be coupled to existing electrical wiring of the structure thereby enabling installation of smart thermostat hub 200 by simply removing the existing thermostat and coupling smart thermostat hub 200 to the existing electrical wiring. For example, smart thermostat hub 200 of FIG. 2 may include a power interface that is configured to be coupled to electrical wiring of a unit using a same configuration as conventional thermostats. Such an installation can be performed with minimal effort and cost (e.g., by decoupling the existing thermostat from the electrical wiring and coupling smart thermostat hub 200 in place of the existing thermostat), thereby significantly reducing the cost to deploy smart thermostat hubs in a multi-family residential property. For example, maintenance personnel may install smart thermostat hub 200 without additional splicing or tapping into the electrical wiring of the unit, and smart thermostat hub 200 may be installed without having to plug smart thermostat hub 200 into a power outlet, thereby reducing a likelihood that a resident would remove smart thermostat hub 200, and without hardwiring smart thermostat hub 200 to the power outlet, thereby preserving the power outlet for use by the resident. Additionally, because smart thermostat hub 200 may be enclosed within a single housing, the likelihood that a resident would tamper with or remove smart thermostat hub 200, and thereby inhibit the benefits that smart thermostat hub 200 provides with respect to security and property management functionality would be minimized. A further advantage of smart thermostat hub 200 is that thermostats may be centrally located within a structure for which they provide control of an HVAC system, such as a central location within an apartment of a multi-family residential property. This may be advantageous as it enables smart hub functionality to be centralized with respect to the apartment, thereby increasing the likelihood that the smart hub's one or more third communication interfaces (e.g., communication interfaces for interacting with smart devices), which may utilize communication links having short range communication capabilities, are within communication range of smart devices present in the apartment, such as a smart door lock.

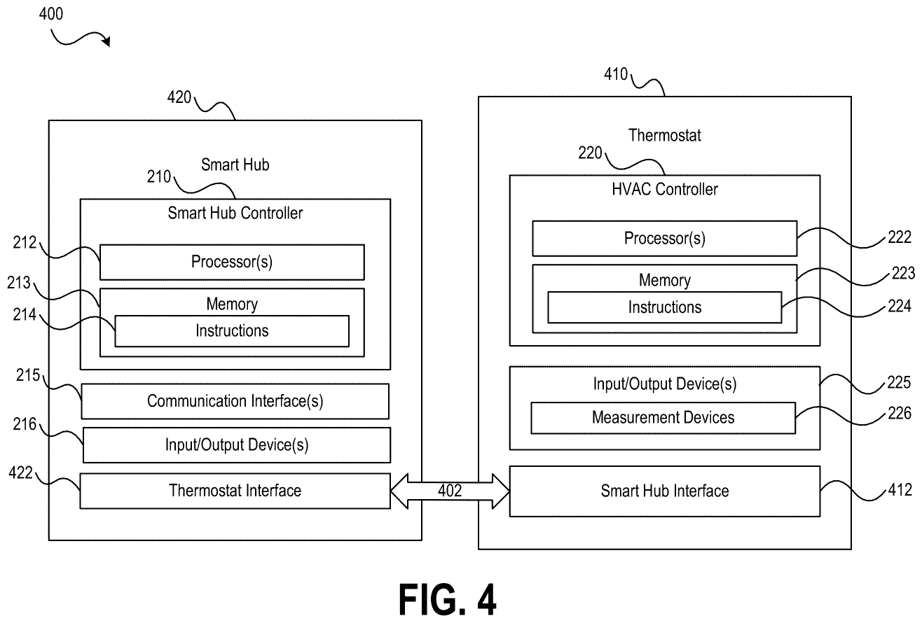

Referring to FIG. 4, a block diagram of a modular smart thermostat hub in accordance with embodiments of the present disclosure is shown as modular smart thermostat hub 400. As shown in FIG. 4, the modular smart thermostat hub 400 may comprise a thermostat component 410 and a smart hub component 420. Thermostat component 410 may comprise the components of smart thermostat hub 200 that provide control over an HVAC system of a structure, such as HVAC controller 220 (including the one or more processors 222 and memory 223 storing instructions 224) and I/O device(s) 225 (including the measurement devices 226). Smart hub component 420 may include components of smart thermostat hub 200 of FIG. 2 and/or smart hub 300 of FIG. 3 that provide the above-described improvements with respect to security and property management through utilization of smart devices, such as a smart door lock, a thermostat, lights fixtures, and the like. For example, as illustrated in FIG. 4, smart hub component 420 may comprise smart hub controller 210 (including the one or more processors 212 and memory 213 storing instructions 214), communication interfaces 215, and I/O device(s) 216.

Additionally, thermostat component 410 may comprise a smart hub interface 412 and smart hub component 420 may comprise a thermostat interface 422. The modular smart thermostat hub 400 may be formed by coupling smart hub interface 412 and the thermostat interface 422, as shown at arrow 402. For example, smart hub interface 412 may comprise one or more pins and the thermostat interface 422 may comprise a connector configured to couple the one or more pins of smart hub interface 412. Alternatively, the thermostat interface 422 may comprise one or more pins and smart hub interface 412 may comprise a connector configured to couple the one or more pins of the thermostat interface 422. It is noted that although smart hub interface 412 and the thermostat interface 422 have been described as being coupled via one or more pins and a connector, this exemplary technique for interfacing smart hub component 420 and thermostat component 410 has been provided for purposes of illustration, rather than by way of limitation and that other techniques and components may be used to couple smart hub component 420 and thermostat component 410.

As shown above, the modular smart thermostat hub 400 may comprise separate components (e.g., thermostat component 410 and smart hub component 420) that, when coupled, facilitate the operations for providing the enhanced security features for managing and securing smart door locks and the improved property management functionality, as described herein. The modular design of the modular smart thermostat hub 400 may provide various advantages over smart thermostat hub 200 and smart hub 300 described above. For example, due to the modular design, a multi-family residential property may be incrementally upgraded to provide the various features described herein, such as installing thermostat component 410 at a first point in time and then installing smart hub component 420 at a second point in time that is later than the first point in time. This may allow a multi-family residential property to be upgraded over time using components (e.g., thermostat component 410 and smart hub component 420) that may be cheaper (individually) than smart thermostat hub 200, enabling the upgrades to be performed as a budget of the multi-family residential property allows. The modular smart thermostat hub may also provide additional advantages regardless of whether the components (e.g., thermostat component 410 and smart hub component 420) of the modular smart thermostat hub are installed at the same point in time or at different points in time. For example, if thermostat component 410 of the modular smart thermostat hub 400 fails, thermostat component 410 may be replaced without replacing smart hub component 420 and if smart hub component 420 of the modular smart thermostat hub 400 fails, smart hub component 420 may be replaced without replacing thermostat component 410. Therefore, the cost of maintaining the modular smart thermostat hub 400 in an operational state over time may be less than smart thermostat hub 200 of FIG. 2. It is noted that the components of the modular smart thermostat hub 400 may be provided within a single housing. For example, thermostat component 410 may comprise a housing that includes a cavity or space within which smart hub component 420 may be provided. The cavity or space within the housing may be accessible through an access panel of the housing.

It is noted that each of the different smart hub configurations illustrated in FIGS. 2-4, which are configured to utilize communication channels or links over a long-range wireless network, such as cellular, LPWAN, or other long-range communication links (e.g., communication link 112 of FIG. 1), provide the additional advantage of not requiring network infrastructure, such as a Wi-Fi network, to be deployed in concert with the deployment of the smart hub devices in order to facilitate operations in accordance with embodiments of the present disclosure. This significantly reduces the costs to deploy the smart hubs in a multi-family residential property. However, it is noted that even in situations where such network infrastructure is present, the smart hubs illustrated in FIGS. 2-4 still provide certain other advantages, as will be described in more detail below with reference to FIG. 7.

Referring back to FIG. 1, during operation of system 100, residents of a multi-family residential property may be provided with access credentials, as described with reference to credential management interface 137. Access credentials may be provided to the residents via one or more user devices 140 or third-party device(s) 160. Examples of user device(s) 140 may include a resident's smartphone, tablet computing device, smartwatch, or other electronic devices having appropriate functionality for interacting with a smart door lock and other smart devices, such as functionality enabling communication via NFC, Bluetooth, Zigbee, Z-Wave, and the like. Examples of third-party device(s) 160 may include key fobs and smartcards provided by the multi-family residential property, such as by an employee or property manager associated with the multi-family residential property.

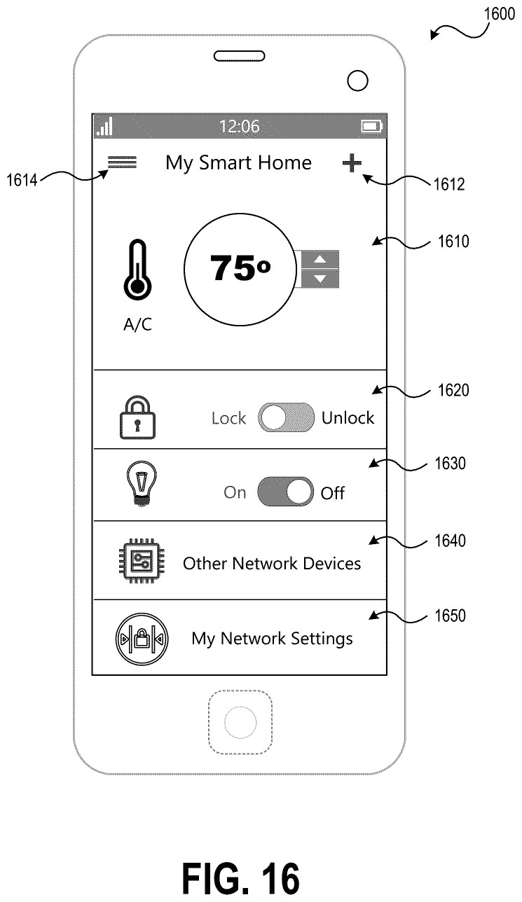

In an embodiment, access credentials may also be provided to the user device(s) 140 via cloud-based service 152 accessible via network 150, such as the Internet. For example, a property management entity associated with a multi-family residential property may provide a website and/or mobile application that residents may utilize to obtain access credentials. The website and/or the mobile application may enable residents to interact with the cloud-based service 152 to request access credentials and perform various tasks relating to the current operating status or settings of each smart device, as will be described in further detail below. In some embodiments, a resident may interact with the website and/or mobile application via a graphical user interface (GUI) provided at the resident's mobile device (e.g., user device(s) 140) to access and control various features of the various smart devices installed at the resident's apartment unit or at a designated common area within the multi-family residential property. An example of such a GUI will be described in further detail below with respect to FIG. 16. The cloud-based service 152 may be configured to generate access credentials in a manner similar to the techniques described above with respect to credential management interface 137 of server 130. For example, after authenticating a resident, the cloud-based service 152 may generate an access credential based on information stored in a database, such as the credential database described above. Once generated, the cloud-based service 152 may provide the access credential to the resident's user device.

As described above, the generation of credentials may not require interaction with a smart door lock. Instead, an access credential may be generated such that when the access credential is presented to the smart door lock (e.g., via placing a device loaded with access credential in proximity to the smart door lock), a result (e.g., a hash value or other information) generated by the credential processing logic of the smart door satisfies an access authorization criterion. The access authorization criterion may comprise a pre-determined value (e.g., a pre-determined hash value or other information) or may comprise a range of pre-determined values. Utilizing access authorization criteria comprised of a range of pre-determined values may facilitate various advantageous features of system 100.

For example, as access credentials are generated, by either the cloud-based service 152 or credential management interface 137, each access credential may be configured to result in a different value within the pre-determined range of values of the corresponding smart door lock, and information that identifies each individual to which an access credential is provided may be recorded (e.g., at the credentials database or another database). The smart door lock may comprise a memory configured to log information associated with each access credential presented to the smart door lock, such as the result generated by the processing logic of the smart door lock in response to presentation of an access credential and timestamp information associated with a time when access credential was presented. The logged information may also include information associated with a state of the smart door lock at the time access credential is present. For example, the state of the smart door lock may be configurable to change between a locked state and an unlocked state, as described above. Each time the state of the smart door lock changes, information indicating the current state of the smart door lock and the time of the state change may be recorded in memory of the smart door lock.

The log of information recorded by the smart door lock may be subsequently retrieved to audit access of the smart door lock. To illustrate, smart hub 110 may be configured to periodically generate and transmit an audit log request that may be transmitted to the smart door lock via a communication link provided by the one or more third communication interfaces of smart hub 110. In response to the request, the smart door lock may transmit the log of information to smart hub 110 via the communication link. Upon receiving the log of information, smart hub 110 may transmit the log of information to server 130 via a first communication link provided by the first communication interface (e.g., a long-range wireless network communication interface), and server 130 may store the log of information in the one or more database 135, such as at an access audit log database. In some embodiments, smart hub 110 may be configured to transmit the log of information to server 130 according to scheduling information provided by server 130 via a long-range wireless network. For example, the data transmission bandwidth provided by the long-range wireless network (e.g., cellular or LPWAN) communication links in some cases may be lower than other types of wireless communication links, such as Wi-Fi, and therefore, transmission of the log of information may take appreciable time. By scheduling transmission of the log of information to server 130 at specific times, which may correspond to off-peak hours (e.g., overnight), interference with other smart hubs of a multi-family residential property may be minimized, which may ensure more reliable communication with smart hubs of the multi-family residential property in an emergency or priority situation, such as if a credential for a smart door lock needs to be disabled.

Additionally or alternatively, server 130 may transmit control information to smart hub 110, where the control information comprises information that identifies the smart door lock and instructs smart hub 110 to obtain at least a portion of the log of information (e.g., information associated with all access credentials presented to the smart door lock, invalid (denied) access credentials presented to the smart door lock, valid access credentials presented to the smart door lock; information associated with changes in the state (actuation events) of the smart door lock; a current state of the smart door lock; and the like), where the portion of the log of information may be specified temporally (e.g., a portion of the log information corresponding to a particular period of time, such as a specified hour, range of hours, day, number of days, a week, and the like), by event type (e.g., state changes, received valid and/or invalid access credentials, disablement of access credentials, authorization of new access credentials, and the like), or both temporally and by event type (e.g., occurrences of one or more particular event types during one or more defined periods of time). It is noted that temporal portions of the retrieved log information may include consecutive time units, such as portions of the log information captured during a consecutive number of hours, days, weeks, and the like. Additionally, the temporal portions of the retrieved log information may include disjoint time units, such as portions of the log information captured on a first day in a week and a third day of the week, a first number of hours in the morning of a particular day and a second number of hours during the evening of the particular day or another day, and the like. The retrieved access log information may include information that identifies particular access credentials associated with the retrieved portion(s) of the information logged by the smart door lock. The ability to probe the smart door lock via control information transmitted by server 130 may improve the security of a multi-family residential property. For example, if a resident is unsure of whether his/her apartment was locked when they left, the resident may contact property management personnel to inquire about the status of the smart door lock, and the property management personnel may utilize a property management platform provided by server 130 to transmit control information to smart hub 110 associated with the resident's apartment. In this example, the control information may identify the smart door lock associated with the resident's apartment and may specify that smart hub 110 is to retrieve only the current status of the smart door lock (e.g., whether the smart door lock is in the locked state or the unlocked state), rather than the entire log of information stored at memory of the smart door lock. By only retrieving the current state of the smart door lock, the requested information may be returned to server 130 more quickly. If the status of the smart door lock is determined to be unlocked, the property management personnel may visit the resident's apartment and secure the smart door lock (e.g., place the smart door lock in the locked state).

In an embodiment, a resident may initiate a status check of the smart door lock via cloud-based service 152. For example, as described above, the resident may access a website or a mobile application via a graphical user interface at the resident's mobile device (e.g., user device(s) 140) that facilitates interaction with the cloud-based service 152. The graphical user interface may provide functionality that enables the resident to view the log of information associated with the smart door lock of the resident's apartment, as well as initiate a status check request to determine a current state of the smart door lock. When a status check request is initiated via the graphical user interface provided by the website or mobile application, the cloud-based service 152 may initiate transmission of a status check request message to server 130 via the network 150. The status check request message may include information identifying the smart door lock for which the status check has been request, such as information that identifies the resident, the resident's apartment number, a smart door lock identifier corresponding to the smart door lock of the resident's apartment, or other information that may be used to identify smart hub located at the resident's apartment. Upon receiving the status check request message, server 130 may obtain information indicating the current status of the smart door lock of the resident's apartment by transmitting control information to smart hub located at the resident's apartment via a long-range wireless communication link, as described above.

Upon receiving the status information from smart hub, server 130 may provide the status information to the cloud-based service 152, which may present information associated with the current status of the smart door lock to the resident via the graphical user interface. The status information may be provided from server 130 to the cloud-based service 152 in a variety of ways. For example, server 130 may store the status information at the access audit log database and then transmit a message to the cloud-based service 152 that indicates the status check request is complete. The cloud-based service 152 may then retrieve the status information from the access audit log database for presentation to the resident via the graphical user interface. Additionally or alternatively, server 130 may include information that indicates the current status of the smart door lock in the response message, which eliminates the need for the cloud-based service 152 to access the access audit log database.

If the status of the smart door lock is determined to be unlocked, the resident may contact property management personnel to request that they visit the resident's apartment and secure the smart door lock (e.g., place the smart door lock in the locked state). The resident may contact the property management personnel to request that the resident's smart door lock be secured via a phone call, a text message (e.g., a text message sent to a number associated with the multi-family residential property for reporting maintenance requests, door security verification requests, and the like), an e-mail message, an instant message (e.g., an instant message created using functionality of the graphical user interface) provided to a device associated with property management personnel, or another method. In an embodiment, a confirmation notification may be provided to the resident once the smart door lock has been secured by the property management personnel.

It is noted that smart hub 110 may also be configured to maintain one or more activity logs, which may be periodically retrieved, in whole or in part, via communication link 112 and network gateway 136 by server 130 or the property management platform provided thereby. Such activity logs may include information associated with various smart devices, such as information that provides historical information associated with how a resident's thermostat is configured (e.g., preferred temperatures, etc.), whether various smart devices, such as lights, were left on for prolonged periods of time, etc. Such information may provide insights into the preferences of the residents of a multi-family residential property, which may be used to automatically customize other experiences of the resident. For example, a resident may gain access to a common area of the multi-family residential property, such as a gym, game room, a media room, and the like, by presenting the resident's access credential. Such access may be detected (e.g., via periodic probing of smart door locks associated with common areas of the multi-family residential property by one or more smart hubs associated with the common areas or via automatic transmission of access information to the one or more smart hubs by the smart door lock via a WPAN or other short-range communication network) and utilized to configure the particular area to perceived preferences of the resident (e.g., a preferred temperature, etc.), where the perceived preferences are derived from the activity log maintained by the smart hub associated with the resident's apartment.

Additionally or alternatively, the resident (e.g., via user device(s) 140) or a property manager (e.g., via server 130) may control one or more settings of the smart devices installed in a common area due at least in part to long-range wireless network connections or communication channels between user device(s) 140/server 130 and smart hub 110. As described above, smart hub 110 may be deployed within the common area to facilitate remote access to, and control of, the smart devices in proximity to smart hub 110 via a WPAN or other short-range communication network (e.g., a Wi-Fi, Zigbee, or Bluetooth network) associated with the common area. For example, a resident wishing to gain entry to the common area may interact with a graphical user interface of a mobile application executing at user device(s) 140 to send an unlock command or instruction to the property management platform, which may forward the unlock command or instruction via a long-range wireless network connection to smart hub 110 for unlocking a smart door lock installed at the common area. The resident may also use the mobile application to send additional commands to smart hub 110 for other smart devices within the common area, e.g., commands for turning on smart lights or operating a smart television within the common area. Likewise, a property manager in this example may use a long-range wireless network connection between server 130 and smart hub 110 to monitor and control various aspects of the common area, such as locking smart door locks, dimming or turning off the smart lights, and controlling the temperature settings of a smart thermostat either after hours or at scheduled times throughout the day.

As described above, server 130 may provide a property management platform that may be utilized to manage various aspects of a multi-family residential property. The property management platform may provide one or more graphical user interfaces that facilitate interaction with smart hubs installed at apartments of the multi-family residential property. To illustrate, the property management platform (e.g., server 130 or a cloud-based implementation of the functionality provided by server 130) may provide a graphical user interface that enables access credentials associated with a smart door lock to be disabled remotely. Via this graphical user interface, a property management user may view access credentials authorized for a particular smart door lock and select one or more access credentials that are to be disabled. Upon confirming which access credential(s) is to be disabled, server 130 may identify one or more smart hubs of the multi-family residential property associated with smart door locks for which the access credential(s) has been authorized (e.g., may be used to lock or unlock the smart door lock(s)), and may transmit control information to the identified smart hubs. For each of the identified smart hubs, the control information may identify the smart door lock and the access credential(s) that is to be disabled for the identified smart door lock.

As explained above, control information provided to a smart hub may include information that identifies one or more smart devices to which the control information pertains and information associated with one or more actions or parameters for modifying a configuration of the one or more smart devices. Continuing with this example, upon receiving the control information from server 130, smart hub(s) may identify one or more smart devices (e.g., one or more smart door locks) and may derive one or more commands for controlling the one or more identified smart devices in accordance with the control information, such as commands to disable access credentials specified in the control information at the identified smart door lock. Having determined the one or more smart devices to which the received control information pertains and deriving appropriate commands for controlling the one or more smart devices in accordance with the control information, smart hub(s) may initiate transmission of the derived commands to the smart devices via one or more communication links provided by a short-range wireless communication interface of each smart hub, and the smart devices may execute the commands. For example, upon receiving the commands, a smart door lock may disable the identified access credentials. In an embodiment, the smart door lock may disable an access credential by configuring a flag associated with the access authorization criteria used by the processing logic of the smart door lock to authenticate presented access credentials. A first value of the flag may indicate access credential is authorized to configure the smart door lock to the locked state and the unlocked state and a second flag value may indicate that access credential has been disabled. Once disabled, access credential may not be used to configure the smart door lock to the unlocked state or the locked state. In an embodiment, smart door locks may comprise an automatic locking mechanism that automatically configures the smart door lock to the locked state when a disable access credential is present. This may further enhance security since a smart lock that is in the unlocked state may be automatically transitioned to the locked state when a disable access credential is presented.

In some embodiments, the control information may be included in a multicast message transmitted by server 130 to a second communication interface of each smart hub via a dedicated multicast communication channel of a long-range wireless network, as described above. The second communication interface may be a second wireless radio of each smart hub, which has been configured for multicast communications. The second communication interface of each smart hub may be configured based on multicast configuration information sent by server 130 to a first communication interface of that smart hub. The first communication interface may serve as a dedicated interface for receiving unicast communications from server 130 while the second communication interface serves as a dedicated interface for receiving multicast communications. The multicast communications may include multicast messages or downlink frames sent by server 130 to a multicast group address associated with a multicast group including the various smart hubs of the multi-family residential property.

In some embodiments, the unicast and/or multicast communications from server 130 may be sent to each smart hub (or multicast group member) through network gateway 136. In some embodiments, network gateway 136 may treat the radios (or unicast and multicast communication interfaces) of each smart hub as separate subnets or segments of the long-range wireless network. Network gateway 136 may connect these subnets or segments together, enabling communication between devices in the different subnets. Accordingly, network gateway 136 may be responsible for routing traffic between the unicast and multicast subnets as necessary. Network gateway 136 may also be responsible for performing any unicast-to-multicast conversion or multicast-to-unicast conversion. Network gateway 136 may maintain routing tables for forwarding data packets between the subnets based on the destination address of each packet. For example, each packet may be addressed to either a unique unicast address associated with a first communication interface of smart hub 110 or a multicast group address associated with a second communication interface of smart hub 110 and other devices in a multicast group, as will be described in further detail below.

In some embodiments, server 130 may use the dedicated multicast communication channel and corresponding interface of each smart hub to control the lock state of multiple smart door locks corresponding to different units of the multi-family residential property. Having a property management platform with multicast support allows a property manager to control smart hubs and other smart devices across multiple units of the multi-family residential property by sending a single multicast message (or downlink frame) rather than having to send multiple messages in a serial manner to the individual devices. This not only saves a significant amount of time, it also reduces communication bandwidth and improves network performance, which may be critical in certain situations. For example, in an emergency lockdown scenario where multiple units may need to be locked due to a security threat (e.g., an armed intruder), the property manager may use server 130 to broadcast a single multicast message including control information for each smart hub in the multicast group to change an operating state of a smart door lock in a corresponding unit of the multi-family residential property from an unlocked state to a locked state (if not already in the locked state). This allows a property manager to quickly and efficiently control the multiple smart door locks across the various units of the multi-family residential property in response to the security threat, e.g., to prevent an armed intruder from entering the premises. As will be described in further detail below, having a dedicated multicast communication channel and smart hubs configured with dedicated communication interfaces for multicast communications also provides an efficient way for a property manager to perform updates (e.g., firmware updates over the air) to maintain the security and reliability of the various smart devices across multiple units of the property.

In addition to remotely controlling a lock state of smart door locks and/or disabling access credentials, property management personnel may manually disable access credentials associated with a smart door lock of system 100, such as by coupling an external device (e.g., a laptop computing device, a tablet computing device, etc.) to the smart door lock and then using an application or utility provided by the external device to manage access credentials. In an embodiment, server 130 may be configured such that access credentials that have been disabled may not be re-enabled via smart hub 110. In this embodiment, a disable access credential may only be re-enabled by coupling the external device to the smart door lock, as described above. In an embodiment, disable access credentials may be re-enabled via control information provided to smart hub 110 by server 130. However, if such capability is provided, system 100 may be configured to require one or more users to authorize the re-enablement of access credential. For example, a manager, supervisor, or other member of property management personnel may need to provide a password in order to re-enable access credential via server 130 and smart hub 110. As another example, remotely re-enabling an access credential via server 130 and smart hub 110 may require authorization from a member of the property management personnel and the resident associated with the smart door lock where access credential is disabled. Requiring the resident to participate in the authorization to remotely enable an access credential may prevent a nefarious individual from gaining entry into the resident's apartment.

In an embodiment, access credentials may also be created (e.g., by either the credential management interface 137 or the system of a third-party service provider, as described above) that comprise information designed to disable another access credential when used. For example, suppose that a first access credential is to be disabled. A second access credential may be generated and configured to include information that is configured to disable the first access credential when the second access credential is presented to a particular smart door lock. The information for disabling the first access credential may include information that identifies the first access credential and other information that specifies an operation associated with the first access credential, such as to disable the first access credential. When the second access credential is presented to the smart door lock, the information for disabling the first access credential may be detected by the smart door lock in addition to detecting the second access credential, thereby enabling the second access credential to be used to change a stat of the smart door lock while also disabling the first access credential. It is noted that such techniques may be utilized to disable multiple access credentials, rather than a single access credential, and may also be utilized to disable one or more access credentials at multiple different smart door locks (e.g., by presenting the second access credential carrying the information for disabling the first access credential at multiple smart door locks where the first access credential has been previously authorized for use). Additionally, access credentials carrying information configured to disable one or more other access credentials may be presented to smart door locks via a user device (e.g., a smartphone, etc.) or via a third-party device (e.g., a fob, a smartcard, etc.).

In addition to providing functionality for managing access credential, the property management platform provided by server 130 and system 100 may also provide additional features that facilitate intelligent management of a multi-family residential property. For example, the one or more database 135 of server 130 may include a resident database that includes information associated with vacant apartments of the multi-family residential property, move-in dates associated with new residents, and move-out dates associated with departing residents. The property management platform may utilize this information to control and automate various property management tasks. For example, the property management platform may periodically (e.g., daily, weekly, monthly, etc.) analyze the resident databased to identify move out dates. When a move out date occurs, the property management platform may transmit control information to a corresponding smart hub (e.g., smart hub 110) of the vacated apartment via the first communication link (e.g., a long-range wireless communication link) to place various smart devices of the apartment into a vacant mode. To illustrate, the control information may identify the thermostat (e.g., the thermostat of smart thermostat hub 200 of FIG. 2 or thermostat component 410 of FIG. 4) of the vacated apartment and may include parameters specifying a temperature that the thermostat should be configured to while vacant. Smart hub 110 may receive the control information, detect that the control information is associated with the thermostat (e.g., based on device identification information included in the control information, and transmit one or more commands to the thermostat via a short-range wireless communication link to modify one or more operational settings of the thermostat in accordance with the control information. The one or more operational settings control at least one of a temperature setting of the thermostat and an operating mode of the thermostat, the operating mode configurable to change between a heating mode, a cooling mode, and an off mode (e.g., to turn the thermostat off).

In an embodiment, the control information may include scheduling information that specifies periods of time during which the thermostat is to be placed in a particular operating mode. For example, the thermostat scheduling information may specify first information that specifies the thermostat is to be configured to a first operating mode (e.g., the heating mode, the cooling mode, or the off mode) for a first period of time and second information that specifies the thermostat is to be configured to a second operating mode (e.g., the heating mode, the cooling mode, or the off mode) that is different from the first operating mode for a second period of time. The first information may be utilized to at least partially heat the vacant apartment during at least a portion of the night during winter months or cool the apartment during at least apportion of the day during summer months. The particular temperatures associated with the first information and the second information may be determined to mitigate potential damage caused by seasonal temperatures, such as to prevent freezing of water pipes, etc. or prevent damage to paint or other potentially heat sensitive surfaces of the apartment. The second information may configure the thermostat to the off mode to minimize the operating costs associated with the vacant apartment. In an embodiment, the thermostat scheduling information may be dynamically generated. For example, the property management platform may be configured to receive weather data (e.g., via an RSS feed or from another third-party source of weather information), and may generate commands to control the configuration of the thermostat based on the weather information, such as to place the thermostat in the heating mode if the weather data indicates severely cold temperatures are expected. As the weather data changes, updates thermostat configuration information may be generated and provided to the thermostat via the smart hub 110, as described herein.

As another example, the control information may identify one or more smart light fixtures of the vacated apartment and may include information that indicates the light fixtures are to be turned off. Smart hub 110 may receive the control information, detect that the control information is associated with the one or more smart light fixtures, and transmit one or more commands to the one or more smart light fixtures (e.g., via one or more corresponding short-range wireless communication links) to turn the one or more smart light fixtures off. Alternatively, the control information may specify that one or more of the smart light fixtures of the vacant apartment are to be, at least periodically, turned on. In such instances, smart hub 110 may transmit additional commands to turn on any smart light fixtures based on the control information, which may include scheduling information that indicates times and dates for turning each applicable light fixture on and/or off.

By using server 130 and smart hub 110 to place vacated apartments into the vacant mode, operating costs associated with the multi-family residential property may be significantly reduced. For example, if a thermostat in a vacated apartment is configured to cool the vacated apartment to a low temperature, the thermostat may remain configured in that state until a new resident moves into the apartment. Operating an HVAC system to cool a vacant apartment for a potentially long period of time may result in significant costs, which are avoided using the above-described techniques.

To illustrate, suppose that a resident prefers a “cold” apartment and configures the thermostat to maintain the apartment at a particular temperature (e.g., <75° F.). If, during a walkthrough performed in connection with the resident vacating the apartment, the thermostat setting is not noticed, the apartment may continue to be cooled in accordance with the settings configured by the resident, thus maintaining the now vacated apartment at the temperature preferred by the former resident. This may cause the property owner (or property management company) to incur significant unnecessary costs associated with cooling a vacant apartment. However, as described herein, a property management platform in accordance with embodiments of the present disclosure may automatically detect (e.g., based on information stored in the one or more databases 135) the apartment has been vacated and via the smart hub 110, may configured the thermostat to the vacant mode, which configures the thermostat's temperature setting to maintain the vacant apartment at a temperature specified by the property management company. This temperature may be higher than temperatures typically configured by residents, such as 80° F. Thus, while the apartment is vacant, the thermostat may maintain the apartment at a higher temperature, resulting in reduced costs during the duration of the vacancy. In an embodiment, the vacant mode may further be configured to turn the thermostat off, at least periodically, such that the HVAC system is not operated at all, which may further reduce the costs associated with the vacant apartment.

Similarly, the above-described techniques for placing a vacant apartment into vacant mode may also eliminate costs associated with light fixtures being allowed to remain on in a vacant apartment. It is noted that in addition to facilitating control of smart devices within apartments of a multi-family residential property, the property management platform may also be utilized to control smart devices associated with public areas of a multi-family residential property, such as gyms, conference rooms, game rooms, parking lots/garages, walking paths, and other common spaces maintained by the property management personnel. For example, the above-described techniques may be utilized to transmit control information (e.g., via a multicast communication channel or link of a long-range wireless network) to respective second communication interfaces of smart hubs (e.g., in a multicast group) communicatively coupled to smart light fixtures and/or thermostats associated with such areas of the multi-family residential property to minimize power consumption and associated costs, such as turning the smart light fixtures off at a particular time (e.g., when a common space is deemed closed), turning the smart light fixtures on at a particular time, such as to light up pathways at night, or increasing the temperature of thermostats at a particular time (e.g., when the leasing office or other area is closed). Further, the property management platform may utilize the above-described techniques to verify whether any smart door locks associated with the areas of the multi-family residential property maintained by the property management personnel were left unlocked, and transmit a notification to a member of the property management if any smart door locks are detected to be in the unlocked state, such as a smart door lock associated with the leasing office.

From the foregoing, it is to be appreciated that the various devices illustrated in FIG. 1, as well as they features they provide, represent a significant improvement to technologies for managing aspects of a multi-family residential property through control of smart devices located within multiple areas of the property. For example, system 100 utilizes long-range wireless communication links or channels to provide backhaul communication between a central location, such as a leasing office or a remote property management platform at a server located away from the property, and smart hubs located at the various apartments (e.g., units) or common areas of the multi-family residential property. In contrast with conventional property management solutions, system 100 does not require a mesh network or Wi-Fi network infrastructure to be deployed throughout the property. This significantly reduces the costs associated with deploying an intelligent property management system, such as system 100 described above, and makes it feasible to deploy intelligent property management systems in certain types of multi-family residential properties, such as Class B and Class C properties, for which previous technologies requiring mesh or Wi-Fi networks were cost prohibitive. System 100 also provides features that improve the security of multi-family residential properties, such as by enabling credentials for smart door locks to be remotely disabled via smart hub 110 and allowing smart door locks to be probed for information associated with a state of the smart door lock or to obtain access log information. Additionally, system 100 provides features that improve property management capabilities, such as by automatically placing vacant apartments into a vacant mode designed to improve the energy efficiency and reduce the operating costs of the multi-family residential property.

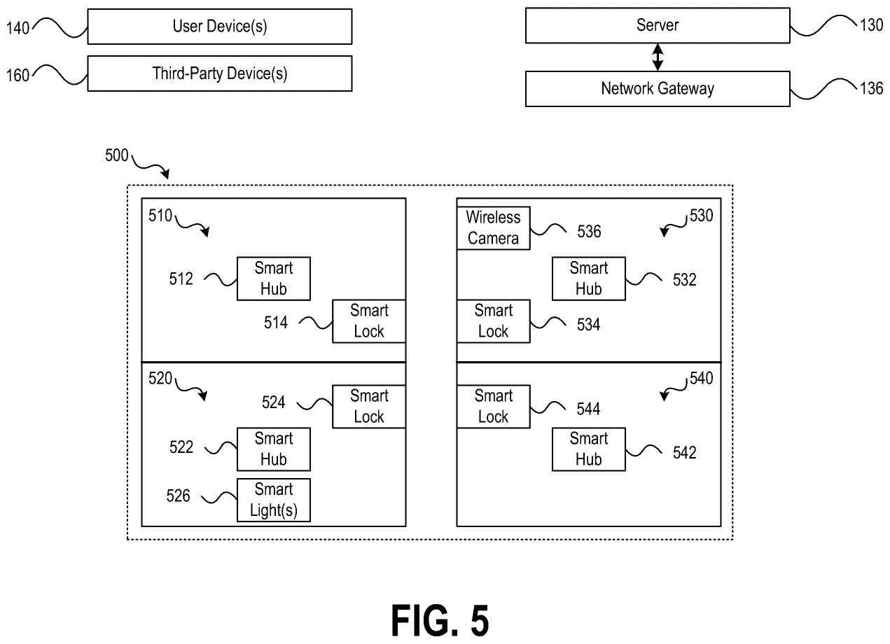

Referring to FIG. 5, a block diagram illustrating aspects of an intelligent property management system configured in accordance with embodiments of the present disclosure is shown. As shown in FIG. 5, a building 500 of a multi-family residential property may include a plurality of apartments (or residential units) 510, 520, 530, 540. The apartments 510, 520, 530, 540 may include smart hubs 512, 522, 532, 542, respectively, which may comprise smart thermostat hub 200 of FIG. 2, smart hub 300 of FIG. 3, or the modular smart thermostat hub 400 of FIG. 4. Additionally, each of the apartments 510, 520, 530, 540 may include a smart door lock, illustrated in FIG. 5 as smart door locks 514, 524, 534, 544. Each of smart hubs 512, 522, 532, 542 may communicate with server 130 via a first communication link (e.g., a long-range wireless communication link) and may communicate with one or more smart devices, such as thermostat or the smart door locks 514, 524, 534, 544, via a second communication link (e.g., a short-range wireless communication link).

As described above, smart hubs 512, 522, 532, 542 may be utilized to control various smart devices (e.g., smart door locks 514, 524, 534, 544) present within the respective apartments of the building 500. For example, suppose that a resident of the apartment 510 left for work and was not sure whether he locked the smart door lock 514 on his way out. As described above with reference to FIG. 1, the resident may utilize user device(s) 140, such as a smartphone, to access a cloud-based service (e.g., the cloud-based service 152 of FIG. 1) hosted by server 130 to obtain the current status of the smart door lock 514. If the resident discovers that he did forget to lock the smart door lock 514, the resident may request that property management personnel visit the apartment 510 and secure (e.g., lock) the smart door lock 514. Once secured, the resident may be notified. Alternatively, the resident may use an application executed by the user device(s) 140 to obtain the current status of the smart door lock 514 and to send a command to smart hub 512 to cause smart hub 512 to issue a command to transition the smart door lock 514 into a locked state. An example of a GUI of such an application is described in further detail below with reference to FIG. 16.

As another example, suppose that two residents live in apartment 530 and each of the residents have an access credential loaded onto third-party device(s) 160, such as a key fob or smartcard, as described above with respect to FIG. 1. If one of the residents living in apartment 530 becomes violent toward the other resident, it may be necessary to prevent the aggressor resident from gaining access to apartment 530. As described above, previous systems that utilized smart door locks would require property management personnel to physically visit the apartment 530 and connect an external device to the smart door lock 534 in order to disable the aggressors access credential. As described above, to disable the aggressor's access credential, the property management personnel may present a credential that includes information designed to disable the aggressor's access credential in order to perform the modification. Depending on the urgency with which the credential needs to be disabled, the property management personnel may not arrive in time to prevent the aggressor resident from gaining entry to the apartment 530 and causing harm to the other resident. However, utilizing the property management platform provided by server 130 through network gateway 136, property management personnel may remotely disable the aggressor resident's access credential by transmitting control information to smart hub 532, where the control information causes smart hub 532 to communicate with the smart door lock 534 to disable access credential. As can be appreciated, this functionality enables access credentials to be disabled quickly, significantly enhancing the security services that may be provided to the residents of the multi-family residential property.

In yet another example, suppose that a resident of apartment 520 has moved out and apartment 520 is now vacant. As described above, the property management platform provided by server 130 may detect the status of the apartment 520 is now vacant and may automatically transmit control information to smart hub 522 to place various smart devices into vacant mode. For example, based on the control information, smart hub 522 may turn off one or more smart lights 526 within the apartment 520 and may configure a thermostat (not shown in FIG. 5) of the apartment 520 to a predetermined temperature. This capability may significantly reduce the power consumption of the multi-family residential property, resulting in significant cost savings. Additionally, the control information provided to smart hub 522 may instruct smart hub 522 to communicate with the smart door lock 524 to disable the former resident's access credentials. This may prevent the former resident or someone possessing the former resident's access credentials from gaining unauthorized access to the apartment after resident has moved out.

Now suppose that apartment 540 is currently vacant, but a new resident is scheduled to move in soon. On the day the new resident is to move in, the property management platform provided by server 130 may transmit control information to smart hub 542 that instructs smart hub 452 to adjust a temperature setting of the thermostat for the apartment 540 in advance of the resident moving in. For example, the control information may be configured to cause the thermostat to start cooling the apartment an hour ahead of a scheduled move in time or at some pre-determined time of day so that the apartment is cooler (relative to the vacant mode) when the resident moves in.

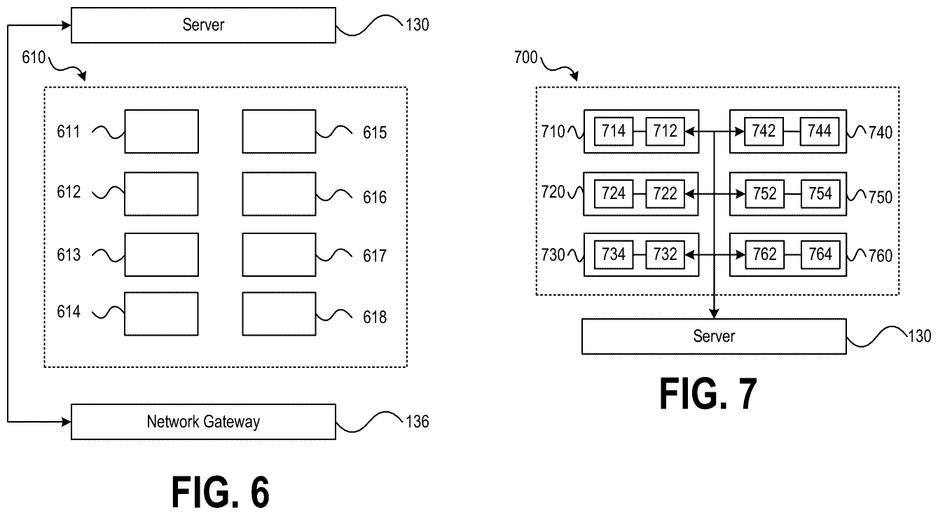

Referring to FIG. 6, a block diagram illustrating additional aspects of an intelligent property management system configured in accordance with embodiments of the present disclosure is shown. As shown in FIG. 6, a multi-family residential property 610 may include a plurality of buildings 611, 612, 613, 614, 615, 616, 617, 618, each building having one or more floors and each floor having at least one apartment. As described an illustrated with respect to FIG. 5, each of the apartments may include a smart hub (e.g., smart hub 110 of FIG. 1, smart thermostat hub 200 of FIG. 2, smart hub 300 of FIG. 3, or the modular smart thermostat hub 400 of FIG. 4), a smart door lock, and other smart devices. Each of smart hubs associated with the apartments of the buildings 611, 612, 613, 614, 615, 616, 617, 618 may communicate with a server 130 providing a management platform that provides various advantageous features for managing a multi-family residential property.

As illustrated in FIG. 6, intelligent property management systems in accordance with embodiments of the present disclosure may include network gateway 136 in conjunction with server 130. The network gateway 136 may be configured to communicatively couple one or more smart hubs to server 130 via a LPWAN and/or to provide overlapping coverage areas for failover purposes. For example, the communication capabilities of the communication links may degrade in some environments or conditions, such as environments with many buildings. In such cases, providing the network gateway 136 may ensure that all smart hubs deployed in a multi-family residential property are communicatively coupled to server 130. In an embodiment, the network gateway 136 may be communicatively coupled to server 130 via a wired communication link (e.g., an Ethernet communication link) or wireless communication link (e.g., a mobile hotspot or other wireless access point providing the gateway with network-based access to server 130). In an embodiment, utilizing the network gateway 136 may enable server 130 to be located at a location other than the multi-family residential property, such as at a corporate office of an entity that owns the multi-family residential property or at another location, or to enable the functionality provided by the server 130 to be access from the cloud. In such instances, access to the property management platform provided by server 130 may be facilitated through a web-based interface, which may be provided by the cloud-based service 152 of FIG. 1.

Referring to FIG. 7, a block diagram illustrating additional aspects of an intelligent property management system configured in accordance with embodiments of the present disclosure is shown. As shown in FIG. 7, a multi-family residential property 700 may include a plurality of buildings 710, 720, 730, 740, 750, 760, each building having one or more floors and each floor having at least one apartment or residential unit. As described and illustrated with respect to FIG. 5, each of the apartment units may include a smart hub (e.g., smart thermostat hub 200 of FIG. 2, smart hub 300 of FIG. 3, or the modular smart thermostat hub 400 of FIG. 4), a smart door lock, and other smart devices. Each of the smart hubs associated with the apartment units of the buildings 710, 720, 730, 740, 750, 760 may communicate with server 130, which provides a property management platform that provides various features for managing a multi-family residential property, as described above with reference to FIGS. 1-4.

Although not wired and/or wireless communication infrastructure, such as Wi-Fi is not necessary to facilitate operation of intelligent property management systems in accordance with the embodiments disclosed herein, such features may provide additional capabilities when present. For example, as illustrated in FIG. 7, a plurality of access points 712, 722, 732, 742, 752, and 762 may be communicatively coupled to server 130 via wired communication links (e.g., Ethernet, etc.) and/or wireless communication links (e.g., Wi-Fi communication links). The bandwidth capabilities provided by the access points 712, 722, 732, 742, 752, and 762 may enable the intelligent property management system to provide video capabilities for improved security. For example, in FIG. 7, each of the buildings 710, 720, 730, 740, 750, and 760 may be equipped with one or more video cameras 714, 724, 734, 744, 754, and 764, respectively. The video cameras 714, 724, 734, 744, 754, and 764 may be communicatively coupled to server 130 via the access points 712, 722, 732, 742, 752, and 762, respectively, to facilitate video monitoring of areas of the multi-family residential property 700, as described above with respect to FIG. 5.

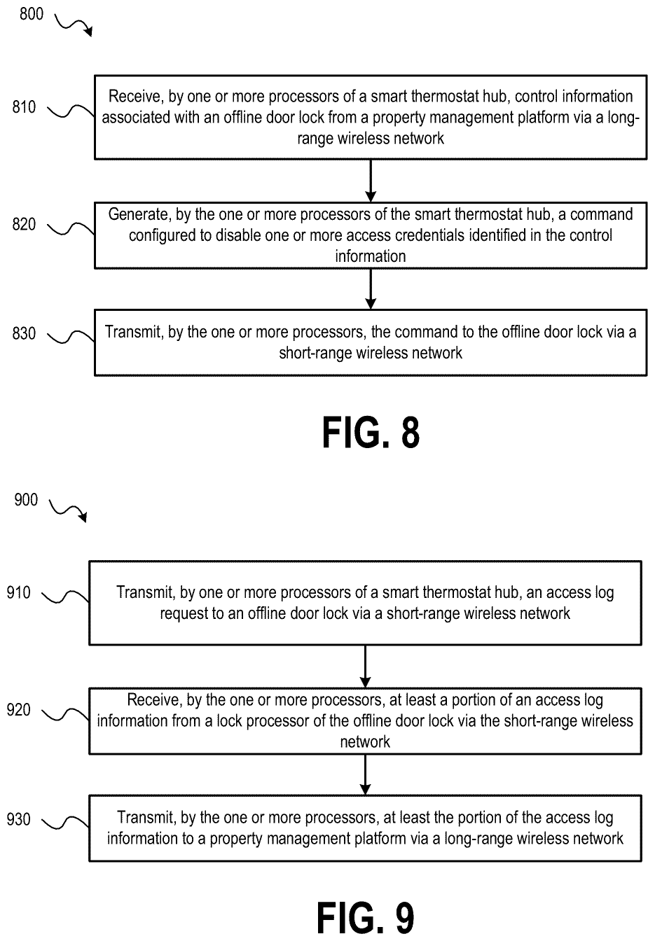

Referring to FIG. 8, a flow diagram illustrating an exemplary method for securing smart devices within an apartment of a multi-family residential property in accordance with embodiments of the present disclosure is shown as method 800. In an embodiment, steps of the method 800 may be stored as instructions that, when executed by one or more processors, cause the one or more processors to perform operations for securing smart devices within an apartment of a multi-family residential property, as described above with reference to FIGS. 1-7. It is noted that the method 800 may be performed by smart hub 110 of FIG. 1, smart thermostat hub 200 of FIG. 2, smart hub 300 of FIG. 3, or the modular smart thermostat hub 400 of FIG. 4.

As shown in FIG. 8, the method 800 may include, at step 810, receiving, by one or more processors of a smart thermostat hub, control information associated with a smart door lock from a property management platform via a long-range wireless network (e.g., a cellular network, LPWAN, or other long-range communication network), where the control information identifies one or more access credentials to be disabled with respect to the smart door lock. At a step 820, the method 800 may include generating, by the one or more processors of smart thermostat hub, a command configured to disable the one or more access credentials identified in the control information. In a step 830, the method 800 may include transmitting, by the one or more processors, the command to the smart door lock via a short-range wireless network (e.g., Bluetooth, Wi-Fi, or other short-range communication network). As described above with reference to FIGS. 1-7, by using a smart thermostat hub in accordance with embodiments of the present disclosure, the method 800 may provide improved security for residents of a multi-family residential property, such as by facilitating access credentials for a smart door lock to be disabled remotely, rather than requiring property management personnel to visit the apartment and couple an external device to the smart door lock.

It is noted that the concepts of method 800 may further facilitate additional advantageous operations. For example, instead of receiving control information for disabling access credentials of the smart door lock, smart thermostat hub may receive control information configured to control operations of a thermostat, a light fixture, or another smart device present in an apartment where smart thermostat hub is located, or may receive control information configured to retrieve status information from a memory of the smart door lock. In a manner similar to steps 810 and 820, this additional control information may be received via a communication channel of a long-range wireless network and may cause the smart thermostat hub to generate one or more commands for controlling operation of smart devices identified by the control information, as described above with reference to FIGS. 1-7. After the one or more commands associated with the additional control information are generated, the smart thermostat hub may transmit the one or more additional commands to the appropriate smart devices via a communication channel of a short-range wireless network. Utilizing a smart thermostat hub with various interfaces for different communication channels to provide control information to smart devices may reduce the cost of deploying an intelligent property management system, such as the intelligent property management system described above with reference to FIG. 1. In some aspects, the method 800 may also be utilized to create access credentials for one or more smart door locks, remotely unlock a smart door lock, or other operations as described above with reference to FIGS. 1-7.

Referring to FIG. 9, a flow diagram of an exemplary method 900 for retrieving access log data from a smart door lock is shown. In an embodiment, steps of the method 900 may be stored as instructions that, when executed by one or more processors, cause the one or more processors to perform operations for securing smart devices within an apartment of a multi-family residential property, as described above with reference to FIGS. 1-7. It is noted that the method 900 may be performed by smart hub 110 of FIG. 1, smart thermostat hub 200 of FIG. 2, smart hub 300 of FIG. 3, and the modular smart thermostat hub 400 of FIG. 4.

At step 910, the method 900 includes transmitting, by one or more processors of a smart thermostat hub, an access log request to a smart door lock via a short-range wireless network. The access log request may be configured to retrieve at least a portion of access log information stored at a memory of the smart door lock. As described above with reference to FIG. 1, smart thermostat hub may be configured to transmit the access log request to the smart door lock in response to control information received from a property management platform (e.g., the property management platform provided by server 130 of FIGS. 1, 5, 6, and 7) and the control information may specify the portion of the access log to be retrieved. At step 920, the method 900 may include receiving, by the one or more processors of smart thermostat hub, at least the portion of the access log information from a lock processor of the smart door lock via the short-range wireless network and at step 930, the method 900 may include transmitting, by the one or more processors of smart thermostat hub, at least the portion of the access log information to the property management platform via a long-range wireless network. As described above, transmission of at least the portion of the access log information to the property management platform may be performed periodically, and may also be performed based on scheduling information received from the property management platform.

It is noted that operations of the method 900 may improve the security of residents of a multi-family residential property. For example, as described above with reference to FIGS. 1 and 5, if residents are not sure they locked the door to their apartment after they leave, the residents may access a cloud-based service (e.g., the cloud-based service 152 of FIG. 1) to determine whether they locked the door or not. The cloud-based service may be configured to communicate with the property management platform to initiate operations of the method 900 to obtain a current status of the smart door lock and provide that status to the resident(s). If the door was found to be unlocked, the resident may contact the property management office to request that property management personnel visit the apartment and secure the smart door lock.

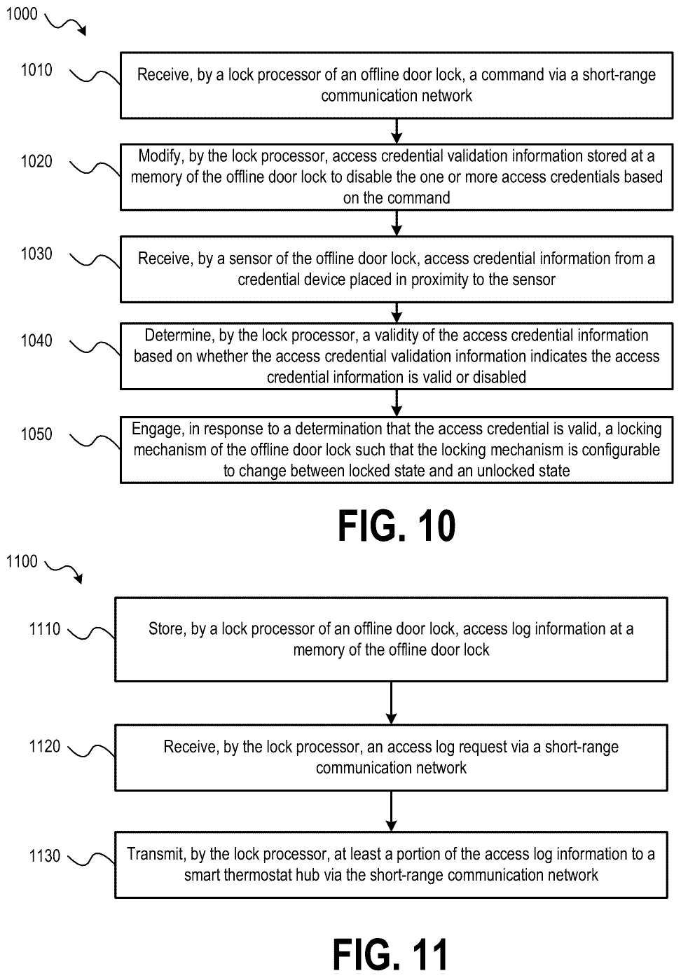

Referring to FIG. 10, a flow diagram illustrating an exemplary method for securing a smart door lock of an apartment of a multi-family residential property in accordance with embodiments of the present disclosure is shown as method 1000. In an embodiment, steps of the method 1000 may be stored as instructions that, when executed by one or more processors, cause the one or more processors to perform operations for securing a smart door lock of an apartment of a multi-family residential property, as described above with reference to FIGS. 1-5. In an embodiment, the method 1000 may be performed by a smart door lock, such as the smart door lock 1200 of FIG. 12.

The method 1000 may include, at step 1010, receiving, by a lock processor of a smart door lock, a command via a short-range communication network (e.g., a WPAN). As described above with reference to FIGS. 1 and 5, as well as FIG. 8, the command may be received from a smart thermostat hub, and may include information for disabling one or more access credentials associated with the smart door lock. At step 1020, the method 1000 may include modifying, by the lock processor, access credential validation information stored at a memory of the smart door lock to disable the one or more access credentials based on the command. As disclosed herein, modifying access credential validation information may include deleting a portion of access credential validation information corresponding to the one or more access credentials identified in the control information. Additionally or alternatively, modifying access credential validation information may include configuring one or more flags corresponding to the one or more access credentials identified in the control information to have a particular flag value. The one or more flags may be stored with access credential validation information and the particular flag value may indicate a corresponding access credential is disabled.

At step 1030, the method 1000 may include receiving, by a sensor of the smart door lock, access credential information from a credential device placed in proximity to the sensor. As described herein, the credential device may include a smartphone, a fob, a smartcard or another type of device provided with an access credential. At step 1040, the method 1000 may include determining, by the lock processor, a validity of access credential information based on whether access credential validation information indicates access credential information is valid or disabled and at step 1050, the method 1000 may include engaging, in response to a determination that access credential is valid, a locking mechanism of the smart door lock such that the locking mechanism is configurable to change between locked state and an unlocked state. It is noted that the method 1000 may provide functionality that is complimentary to the functionality provided by the method 800. Additionally, as described above with reference to FIGS. 1-6, providing an intelligent property management system that includes a smart thermostat hub to enable access credentials for smart locks to be remotely disabled in accordance with the method 1000 provides improved security for residents of a multi-family residential property, such as by facilitating access credentials for a smart door lock to be disabled remotely, rather than requiring property management personnel to visit the apartment and couple an external device to the smart door lock. Further, it is noted that although the method 1000 is described as providing functionality for disabling access credentials, the method 1000 may also be utilized to provide other functionality described herein with respect to operations of a smart door lock in accordance with aspects of the present disclosure, such as authorize new credentials.

Referring to FIG. 11, a flow diagram illustrating an exemplary method for securing a smart door lock of an apartment of a multi-family residential property in accordance with embodiments of the present disclosure is shown as method 1100. In an embodiment, steps of the method 1100 may be stored as instructions that, when executed by one or more processors, cause the one or more processors to perform operations for securing a smart door lock of an apartment of a multi-family residential property, as described above with reference to FIGS. 1 and 5. In an embodiment, the method 1100 may be performed by a smart door lock. An example of such a smart door lock will be described below with reference to FIG. 12.

At step 1110, the method 1100 may include storing, by a lock processor of a smart door lock, access log information at a memory of the smart door lock. As disclosed herein, the access log may comprise access credential information associated with access credentials presented to the sensor and/or status information identifying changes to a state of a locking mechanism of the smart door lock. Additionally, the access log information may comprise time stamps associated with the time that particular information was recorded to the access log. At step 1120, the method 1000 may include receiving, by the lock processor, an access log request via a short-range communication network. At step 1130, the method 1100 may include transmitting, by the lock processor, at least the portion of the access log information to a smart thermostat hub via the short-range communication network. As described above with respect to FIGS. 1 and 5, the access log request may be received by the lock processor from a smart thermostat hub that is in communication with a property management platform, and the request for access log information may ultimately be provided to the property management platform or another destination, such as a graphical user interface associated with the cloud-based service 152 of FIG. 1.

It is noted that the method 1100 provides functionality that is complimentary to, and that may be used in conjunction with, the functionality provided by the method 900. For example, as described above with reference to FIGS. 1 and 5, if residents are not sure they locked the door to their apartment after they leave, the residents may access a cloud-based service (e.g., the cloud-based service 152 of FIG. 1) to determine whether they locked the door or not. The cloud-based service may be configured to communicate with the property management platform to initiate operations of the method 900 to obtain a current status of the smart door lock and provide that status to the resident(s). If the door was found to be unlocked, the resident may contact the property management office to request that property management personnel visit the apartment and secure the smart door lock. Thus, it is to be appreciated that the operations of the method 1100, individually or in coordination with other processes, such as the method 900 described with reference to FIG. 9, may improve the security of residents of a multi-family residential property.

Referring to FIG. 12, a block diagram illustrating exemplary features of a smart door lock configured in accordance with embodiments of the present disclosure is shown as a smart door lock 1200. As shown in FIG. 12, the smart door lock 1200 may include a lock processor 1210, a sensor 1212, a communication interface 1214, a memory 1220, a locking mechanism 1230, and a lock control mechanism 1240. The sensor 1212 may be configured to receive access credential information from a credential device placed in proximity to the sensor 1212. For example, the sensor 1212 may be configured to utilize near field communication (NFC) or Bluetooth communication to receive access credentials from an credential device (e.g., a resident's smartphone, a fob, a smartcard, and the like). Communication interface 1214 may be configured to communicatively couple the smart door lock 1200 to smart hub 110 via a short-range communication network (e.g., a WPAN, such as a Bluetooth network). In an embodiment, the sensor 1212 may be omitted and the communication interface 1214 may be configured to utilize one or more short-range communication links, such as a Bluetooth communication link, a Zigbee or Z-Wave communication link, and/or other types of short-range communication links, to communicate with a smart thermostat hub and/or to receive, disable, or otherwise manage access credentials, as described herein.

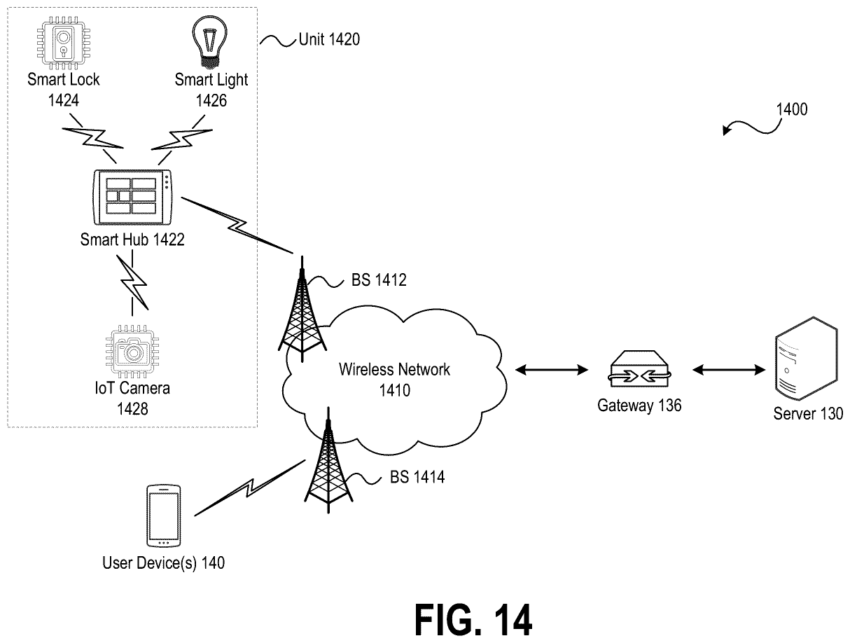

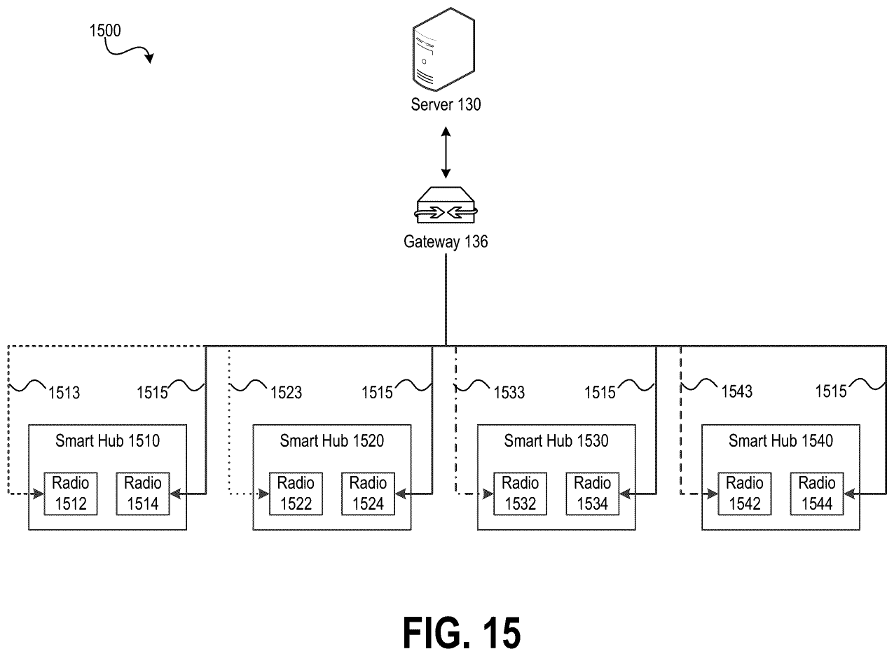

In an embodiment, communication interface 1214 may include one or more wireless communication interfaces configured to communicatively couple the smart door lock 1200 directly to a remote system, such as a server of a property management platform configured in accordance with embodiments of the present disclosure. In such an embodiment, rather than communicating with a smart hub to perform various operations with respect to the smart door lock 1200, as described above, the server of the property management platform (e.g., server 130 of FIG. 1) may communicate control information directly to smart door lock 1200 via a gateway (e.g., network gateway 136 of FIG. 1) within a wireless network, such as to retrieve at least a portion of the log information maintained by smart door lock 1200, manage access credentials associated with smart door lock 1200, or other operations described herein. In some implementations, the gateway may be a long-range wireless network gateway device, such as a LoRaWAN or other LPWAN gateway device or a cellular gateway device, which supports low-power, long-range radio communications between the server and the smart door lock 1200 or other smart devices. Because smart door lock 1200 includes, for example, a long-range wireless network communication interface, smart door lock 1200 may be able to bi-directionally communicate with the property management platform, such as to transmit a requested portion of the access log information to the property management platform via a network gateway using one or more long-range wireless communication channels, as described above and as will be described in further detail below with respect to FIGS. 14 and 15.

As shown in FIG. 12, memory 1220 of the smart door lock 1200 may store access credential data 1222 and access log data 1224, as described above with respect to FIGS. 9-11. As described above, the lock processor 1210 may be configured to determine a validity of access credential validation information presented to the sensor 1212 (or the communication interface 1214) based on the access credential data 1222. Additionally, the lock processor 1210 may be configured to selectively engage the lock control mechanism 1240 based on whether the access credential information is valid.

In an embodiment, the locking mechanism 1230 comprises a deadbolt 1232 and the lock control mechanism 1240 may comprise a rotatable member 1242. In other implementations, the deadbolt 1232 may be replaced with a different type of locking mechanism, such as one or more pins of a tubular lock or one or more pins or levers of a mortise lock. The locking mechanism 1230 may be configurable to change between the locked state and the unlocked state via rotation of the rotatable member. For example, in response to successful authentication of access credentials presented to the sensor 1212 (e.g., the presented access credential information is determined to be valid), the lock processor 1210 may engage the lock control mechanism 1240, and the engagement of the lock control mechanism 1240 may facilitate interaction between the lock control mechanism 1240 and the locking mechanism 1230. For example, engagement of the lock control mechanism 1240 may configure the rotatable member 1242 such that rotation of the rotatable member 1242 in a first direction drives the deadbolt 1232 to a first position corresponding to the locked state, as shown at 1202, and rotation of the rotatable member 1242 in a second direction drives the deadbolt 1232 to a second position corresponding to the unlocked state, as sown at 1204. The lock processor 1210 may be configured to ignore invalid or disabled credentials. In such instances, interaction between the lock control mechanism 1240 and the locking mechanism 1230 may be prohibited. For example, when an invalid or disabled credential is presented, the lock control mechanism 1240 may not be engaged by the lock processor 1210 in response to receipt of an invalid access credential and the locking mechanism 1230 may be maintained in a current state (e.g., either the locked state or the unlocked state). In such instances, the rotatable member 1242 may freely rotate without impacting the locking mechanism 1230. As another example, rotation of the rotatable member 1242 may be prevented, thereby causing the lock control mechanism to maintain a current state (e.g., either the locked state or the unlocked state). Thus, in the absence of engagement of the locking mechanism 1230, the locking mechanism 1230 may remain in the locked state or the unlocked state (e.g., until a valid credential is presented).

In an embodiment, the lock control mechanism 1240 may include one or more electro-mechanical components 1244, such as one or more circuits, motors, actuators, gears, or other components, configured to electrically, mechanically, or electro-mechanically configure the locking mechanism 1230 to change between the locked state and the unlocked state. For example, in response presentation of a valid access credential, the one or more electro-mechanical components 1244 may be activated to automatically drive the deadbolt 1232 to the first position or the second position. In response to presentation of an invalid access credential, the one or more electro-mechanical components may be configured to maintain the locking mechanism 1230 in a current state (e.g., the deadbolt 1232 may be maintained at the first position or the second position). In embodiments comprising a smart door lock 1200 that includes electro-mechanical components 1244, the smart door lock 1200 may further include a power supply, such as a battery or other power source, configured to supply operational power to the electro-mechanical components 1244.

In addition to controlling the electro-mechanical components 1244 in response to valid access credentials, in an embodiment, the lock processor 1210 may be configured to activate or otherwise control the electro-mechanical components 1244 to configure the locking mechanism 1230 to change between the locked state and the unlocked state in response to commands received via a short-range wireless network (e.g., WPAN) communication link, such as commands received from a smart hub configured in accordance with embodiments of the present disclosure. As described above, the smart hub may be configured to generate such commands (e.g., lock commands and/or unlock commands) responsive to control information provided by a property management platform (e.g., the system 100 of FIG. 1) via a long-range wireless network (e.g., LPWAN) communication link (e.g., via server 130 and network gateway 136 of FIG. 1). Additionally, the control information received at the smart hub may be generated by the property management platform in response to information received via a user interface, such as the user interface described above that allows a resident (or property management personnel) to verify a status of the smart door lock as locked or unlocked. For example, if a status check indicates the smart door lock is unlocked, a request may be initiated from the user interface to property management platform to lock the smart door lock. In response to such a request, control information identifying the smart door lock and including an instruction to configure the smart door lock to the locked state may be communicated to the appropriate smart hub via the long-range communication link and then the commands may be provided from the smart hub to the smart door lock via a short-range communication link, such as a Bluetooth low energy (BLE) communication link, a Zigbee communication link, a Z-Wave communication link, etc.

In an embodiment, the smart door lock 1200 may not be configured to facilitate the use of remote unlock commands irrespective of whether the smart door lock 1200 includes the electro-mechanical components 1244. For example, although access credentials may be disabled or enabled/provided via commands received from a smart hub in response to control information transmitted to the smart hub by a property management platform, the smart door lock 1200 may be prevented from enabling the locking mechanism to change between the locked state and the unlocked state via commands received from the smart hub. In this example, the smart door lock 1200 may only enable the locking mechanism to change between the locked state and the unlocked state when a valid access credential is received (e.g., via the sensor 1212 or the communication interface 1214) from a user device (e.g., smartphone, etc.) or third-party device (e.g., a fob, a smartcard, etc.).

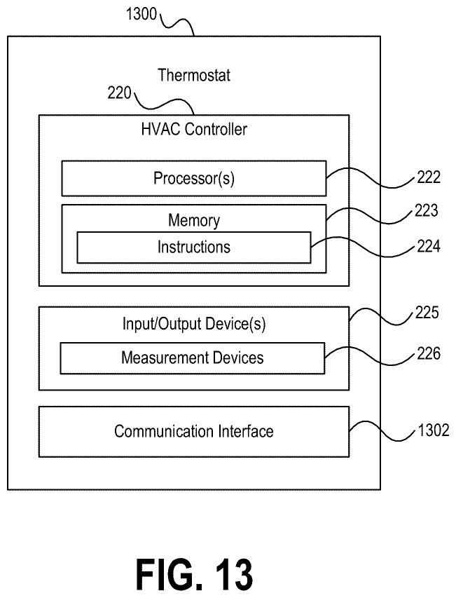

Referring to FIG. 13, a block diagram illustrating an example of a smart thermostat 1300 in accordance with embodiments of the present disclosure. As shown in FIG. 13, the smart thermostat 1300 may include the components illustrated with respect to the thermostat component 410 of FIG. 4, however, rather than including the smart hub interface 412, the smart thermostat 1300 may include a communication interface 1302. For example, communication interface 1302 of the smart thermostat 1300 may be communicatively coupled to a property management platform (e.g., the system 100 of FIG. 1) via a long-range wireless communication link, and may receive control information from the property management platform directly, as opposed to receiving commands derived from control information by a smart hub. Such a direct communication link may enable operational aspects of the smart thermostat 1300 to be configured, such as temperature settings, operating modes, and the like as described above, to be configured via control information provided by the property management platform (e.g., via server 130 and network gateway 136 of FIG. 1) without requiring a smart hub to be provided in proximity to or in connection with the smart thermostat 1300. In this manner, the advantages provided by utilizing a smart hub to control a thermostat, such as to place the thermostat into vacant mode or other advantageous operations, may be provided by the smart thermostat 1300 directly, thereby providing a more cost effective solution for situations where the additional functionality provided by the smart hub (e.g., short-range communication with smart door locks and other smart devices) may not be desired or practical. In some embodiments, communication interface 1302 may include a plurality of communication interfaces corresponding to various long-range communication channels or links (e.g., unicast and multicast communication channels over a long-range wireless network) between the smart thermostat 1300 and a server (e.g., server 130 of FIG. 1) of the property management platform, as described above and as will be described in further detail below.

FIG. 14 is a block diagram of an exemplary system 1400 for managing and controlling smart devices within a unit of a multi-family residential property over one or more wireless networks in accordance with embodiments of the present disclosure. For discussion purposes, system 1400 will be described with reference to various components of system 100 of FIG. 1, as described above, but system 1400 is not intended to be limited thereto.

As shown in FIG. 14, system 1400 includes a server 130 that communicates over a wireless network 1410 with one or more user devices 140 and a smart hub 1422 of a unit 1420 of the multi-family residential property. Wireless network 1410 may be a long-range wireless network, such as a cellular network or a LPWAN, which is used to facilitate communications between smart hub 1422 and other computing devices, including server 130 and user device(s) 140. In some embodiments, server 130 may be used to provide a property management platform for remotely managing and controlling the smart devices associated with unit 1420 via wireless network 1410. Unit 1420 may be one of a plurality of units within the multi-family residential property, where each unit has its own smart hub and associated smart devices, e.g., as described above with respect to FIG. 5. Unit 1420 may correspond to, for example, an apartment or residential unit (e.g., apartment 520 of FIG. 5) within an apartment building of the multi-family residential property. Alternatively, unit 1420 may correspond to a designated common area or facility of the property (e.g., a fitness center, a laundry room, a clubhouse, etc.). In some implementations, smart hub 1422 may be a smart thermostat hub (e.g., smart thermostat hub 200 of FIG. 2 or modular smart thermostat hub 400 of FIG. 4, as described above) installed on an interior wall of unit 1420. In such implementations, smart hub 1422 may be capable of controlling one or more thermostat settings in addition to communicating with other smart devices and server 130. In other implementations, smart hub 1422 may be a smart device hub that communicates with a separate smart thermostat device and other smart devices.

User device(s) 140 may include or correspond to a mobile device associated with a resident of unit 1420 or a property manager of the multi-family residential property. The smart devices within unit 1420 may include, for example and without limitation, a smart lock 1424, a smart light 1426, a smart wireless or Internet of Things (IoT) camera 1428, and a smart thermostat integrated with or coupled to smart hub 1422. IoT camera 1428 may be, for example, a webcam or a wireless security camera that can be remotely controlled by the property manager via server 130 or by the resident via user device 140. The resident in this example may use the application at user device 140 to view a live or recorded video stream captured by IoT camera 1428 for purposes of surveillance and monitoring unit 1420 when it is unoccupied. Depending on the bandwidth capabilities of wireless network 1410, video captured by IoT camera 1428 may be streamed in real-time (or near real-time) to user device 140 or server 130. Additionally or alternatively, the video may be stored in the cloud (e.g., on a cloud server or remote database) accessible to the user device 140 via wireless network 1410. Each of the smart devices within unit 1420 may be communicatively coupled to smart hub 1422 via a short-range wireless network (e.g., a Bluetooth network, a BLE network, a Zigbee network, a Z-Wave network, a Matter or Matter-compliant network, a Thread or Thread-compliant network, or another type of short-range wireless network).

In some embodiments, server 130 may be communicatively coupled to a gateway 136 that relays communications between server 130 and other devices (including smart hub 1422 and user device 140) over wireless network 1410. While gateway 136 is shown separately from wireless network 1410 in FIG. 14, it should be appreciated that gateway 136 in some implementations may be a gateway device within wireless network 1410 that is communicatively coupled to server 130. In other implementations, gateway 136 may be a network gateway device outside of wireless network 1410 that enables low-power long-range radio communications utilizing low-power cellular communication links (e.g., based on LTE-M or NB-IoT technology standards) between server 130 and other devices (e.g., smart hub 1422) via wireless network 1410. However, it should be appreciated that embodiments are not limited thereto and that any of various network gateways may be used as appropriate or desired for a particular implementation.

In some implementations, wireless network 1410 may be a LPWAN. As described above, such an LPWAN may include a low power, wide range (or long-range) wireless communication network. For example, the LPWAN may include or correspond to a LoRaWAN, a NB-IoT network, a Sigfox-based network, a Weightless network, a DASH7 network, a Wize network, a CSS-based network, a MIoTy network, an IEEE 802.11ah network, or the like. In a LoRaWAN implementation, a base station (BS) 1412 and a BS 1414 may function as gateways for routing data to and from LoRaWAN-enabled devices (e.g., smart hub 1422 and/or other smart devices).

Alternatively, wireless network 1410 may be a cellular network, such as a low power cellular network (e.g., LTE-M or LTE-MTC) or other type of cellular network. Accordingly, wireless network 1410 may support any of various cellular communication standards, protocols, and technologies. Examples of such standards and protocols include, but are not limited to, 3G, 4G, 4G Long Term Evolution (LTE), and 5G. Examples of cellular technologies that may be supported by wireless network 1410 include, but are not limited to, Global System for Mobile Communications (GSM), General Packet Radio Service (GPRS), Code-Division Multiple Access (CDMA), Frequency-Division Multiple Access (FDMA), Orthogonal Frequency-Division Multiple Access (OFDMA), Space-Division Multiple Access (SDMA), multiple-input and multiple-output (MIMO), etc. In a cellular network implementation, BS 1412 and BS 1414 may correspond to physical elements of a radio access network (RAN), as will be described in further detail below.

In some embodiments, wireless network 1410 may be associated with a wireless operator or carrier. An operator or carrier can be, for example and without limitation, a wireless service provider that provides various communication services to mobile phone subscribers. The services provided by the carrier may include, for example and without limitation, messaging services for sending messages with text and/or multimedia content over Internet Protocol (IP) networks including the Internet or similar networks. As will be described in further detail below, messaging services involving the communication of secured or encrypted data may be provided by the wireless carrier/operator using a secure communication channel via a radio access network (e.g., 3G or 4G data network) of the overall mobile communication network. In some implementations, this radio access network may be of a different type than the radio access network (e.g., based on One (1) times (x) Radio Transmission Technology or “1×RTT”) used for voice calls routed through the overall mobile communication network.

While not shown in FIG. 14, it should be appreciated that wireless network 1410 may include any number of intermediate network routers, gateways (e.g., including gateway 136), or servers between network components/devices. It should also be appreciated that individual elements (e.g., switches, gateways and/or routers) forming the traffic network are omitted from FIG. 14 for case of discussion. Although not separately shown, wireless network 1410 may include or communicate with any number of service control elements. Such service control elements may include, for example, elements for authenticating smart hub 1422 and user devices 140 to access wireless network 1410. Additionally, such elements may include authorization control elements for authorizing users or devices for accessing various communication services and features offered by wireless network 1410. Further, such elements may include a billing system for purposes of usage accounting and billing functions of wireless network 1410. Some of these functions may require the transmission of authentication credentials or information from smart hub 1422 and user device(s) 140 (e.g., on a periodic basis for security reasons).

In some implementations, wireless network 1410 may include an inter-carrier or other intermediate network gateway to enable communications between wireless network 1410 and the wireless communication networks of different wireless carriers. Wireless network 1410 offers a variety of text and other data services, including services via the Internet. Such services may include, for example and without limitation, services for downloading applications and other types of content, web browsing, and various messaging services, including exchange services for electronic mail (“e-mail”) as well as Short Messaging Service (SMS) and Multimedia Messaging Service (MMS) for sending and receiving text and multimedia messages, respectively. Such messaging services may also provide support for secured message communications (e.g., secured text and/or multimedia messages) between, for example, a user of a user device 140 and other mobile device users or a property manager (e.g., via server 130) through wireless network 1410 and/or other communication networks (e.g., the Internet).

In some implementations, the data traffic portion of wireless network 1410 connects to other public packet switched data communication networks (not shown) in addition to the Internet. Packet switched communications via the traffic network of wireless network 1410 and the Internet may support a variety of messaging and other types of communications services for mobile device users. As such, the wireless carrier or service provider that operates wireless network 1410 generally also operates a number of systems that provide ancillary functions in support of the communications services provided through wireless network 1410. For example, wireless network 1410 may include one or more message servers, which may be used to provide different types of messaging services to various devices (e.g., smart hub 1422 and/or user devices 140) through wireless network 1410. Examples of such message servers include, but are not limited to, a short message service center (SMSC) server for SMS messages, a multimedia message service center (MMSC) server for MMS messages, an enhanced message service center (EMSC) server for enhanced messaging service (EMS) messages, and the like.

In some implementations, wireless network 1410 includes multiple interconnected access networks for providing voice and data communication services to mobile device subscribers/users. Hence, wireless network 1410 overall may include a number of radio access networks (RANs), as well as regional ground networks interconnecting a number of RANs and a wide area network (WAN) interconnecting the regional ground networks to core network elements. A regional portion of wireless network 1410, such as that serving user device(s) 140 or smart hub 1422, will typically include one or more RANs and a regional circuit and/or packet switched network and associated signaling network facilities. Physical elements of a RAN are generally operated by a mobile network operator or wireless carrier of wireless network 1410. Such physical elements include a number of base stations, as represented in the example shown in FIG. 14 by BS 1412 and BS 1414.

Although not separately shown, each of base stations 1412 and 1414 may include a base transceiver system (BTS). A BTS communicates via an antennae system at the site of the respective base stations 1412 and 1414 via an over-the-air communication link with one or more mobile devices that are within a particular signal coverage range of the BTS. The BTS is the part of the radio network that sends and receives RF signals to/from smart hub 1422 and user device(s) 140, as served by base stations 1412 and 1414, respectively. The BTS may utilize transceiver equipment to implement communications in accordance with the appropriate wireless communication standards and protocols supported by the network, e.g., for purposes of signaling, registration, voice communication, data communication, etc. Thus, each of base stations 1412 and 1414 is configured to broadcast certain standardized information (e.g., in accordance with appropriate wireless communication protocols) to smart hub 1422 and user device(s) 140 (in addition to any other mobile devices (not shown) within range of the particular base station) so as to enable each device to find and establish a communication link with the base station via wireless network 1410.

In some implementations, device-specific information for each device may be stored within a network database (not shown) in association with a unique device identifier for that device. Examples of such a unique mobile device identifier may include, but are not limited to, a mobile device identifier is a Mobile Directory Number (“MDN”), a Mobile Equipment Identifier (“MEID”) or a Mobile Identifier Number (“MIN”). For example, the mobile device identifier associated with a mobile device may be used by the wireless carrier to identify the particular device for determining whether or not the device is on the same or a different wireless carrier's mobile communication network. The device-specific information may include, for example, subscriber data related to different subscribers or users of the connected devices (e.g., user devices 140, smart hub 1422, or other smart devices) for purposes of accessing secured messaging services provided through wireless network 1410. The subscriber data may also include security credentials associated with a subscriber/user associated with each device for authenticating the particular subscriber/user to send and receive secured messages through wireless network 1410.

In some embodiments, user device(s) 140 may be used by a resident and/or a property manager to control smart devices associated with unit 1420 via remote connections established indirectly with the smart devices over wireless network 1410 or via direct connections established while located in proximity to the smart devices, such as via short range or point-to-point connections. Additionally, or alternatively, user device(s) 140 may access a cloud-based service (e.g., cloud-based service 152 of FIG. 1, as described above) provided by server 130 over wireless network 1410 to communicate with and control the smart devices associated with unit 1420. In some implementations, such a cloud-based service may be part of the property management platform provided by server 130, as described above.

As will be described in further detail below, a user (e.g., a resident or a property manager) may access various features of the property management platform provided by server 130 by interacting with a graphical user interface (GUI) of an associated property management application or website loaded in a browser executable at a computing device of the user (e.g., user device(s) 140). For example, the application or website may enable the user to request access credentials and/or initiate various tasks relating to the management and control of one or more of the smart devices in unit 1420. Accordingly, server 130 may coordinate with smart hub 1422 to perform such tasks based on input received from the user via the application or website.

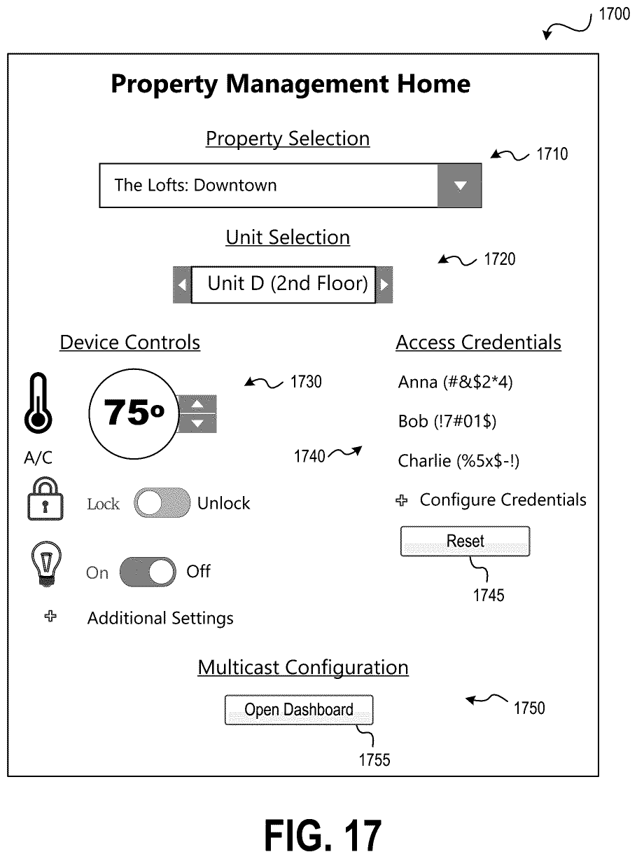

In some embodiments, smart hub 1422 may manage and control an operating state or operating settings of a smart device of unit 1420 on behalf of server 130 based on control information received from server 130 via wireless network 1410, e.g., a long-range wireless network. The control information received from server 130 may be used by smart hub 1422 to provide corresponding instructions or other communications to one or more of smart devices 1424, 1426, and 1428 via a short-range wireless network (or one or more communication channels thereof) based on the control information. In an example, smart hub 1422 may receive control information from server 130 that identifies smart lock 1424 and directs smart hub 1422 to change an operating state of smart lock 1424 to an unlock state. Smart hub 1422 may in turn generate and transmit an unlock command to smart lock 1424 via the short-range wireless network. As another example, control information that identifies smart light 1426 and a lighting setting may be received by smart hub 1422 from server 130 via wireless network 1410, and smart hub 1422 may generate and transmit a command to smart light 1426 via the short-range wireless network to cause smart light 1426 to set a power level based on the lighting setting. Other examples of operations are described above with reference to FIGS. 1-13. Furthermore, secure messages and notifications relating to an operating status or one or more operating settings of a smart device associated with unit 1420 may be transmitted by smart hub 1422 over wireless network 1410 for display via a graphical user interface (GUI) of a property management application executable at server 130, as will be described in further detail below with respect to FIG. 17. In yet another example, secure messages and notifications relating to an operating status or one or more operating settings of a smart device associated with unit 1420 may be transmitted by smart hub 1422 over wireless network 1410 for display via a GUI of a client or mobile application executable at user device(s) 140, as will be described in further detail below with respect to FIG. 16.

In some implementations, smart hub 1422 may be configured to support one or more device or network reset (or “wipe”) operations in order to prepare unit 1420 for occupancy by a new resident after a previous resident moves out. For example, after the previous resident moves out, smart hub 1422 may receive control information including a reconfigure command from server 130 via wireless network 1410. Based on receiving the reconfigure command, smart hub 1422 may send signaling or instructions to each of smart devices 1424, 1426, and 1428 to delete any settings made by the previous resident from the devices, to delete any identification information associated with the previous resident or the previous resident's devices, to reset one or more settings of the devices to initial or default settings, and/or perform any other appropriate reconfiguration operations. Supporting such reconfiguration commands and operations may enable the property manager to return smart devices that remain in unit 1420 after the previous resident has moved out to a default operating state with initial settings that enable the devices to be configured by or for the new resident and personal devices thereof. This remote controlled reconfiguration may save substantial time and costs as compared to having an employee or agent of the property manager go to unit 1420 in person to manually reconfigure or reset the smart devices each time a resident moves out of unit 1420, thereby providing significant benefit to a property manager of the multi-family residential property.

As the multi-family residential property includes multiple units with various smart devices that may need to be periodically configured or reconfigured (e.g., due to vacancies after residents move out or other circumstances), the disclosed property management system and techniques with unicast and multicast support may be utilized to save the property manager even more time and costs. In some embodiments, the control information for controlling or reconfiguring the smart devices associated with unit 1420 and other units of the multi-family residential property may be received by smart hub 1422 from server 130 via a dedicated multicast communication channel of wireless network 1410. For example, smart hub 1422 may include separate uniquely addressable communication interfaces (or radios) that correspond to dedicated unicast and multicast communication channels between smart hub 1422 and server 130 over wireless network 1410. In such an example, a first communication interface of smart hub 1422 may be configured to receive unicast communications sent by server 130 to a unique unicast address associated with the first communication interface via a first communication channel (e.g., a dedicated unicast channel) of wireless network 1410. In some embodiments, server 130 may send control information to the first communication interface of smart hub 1422 to cause smart hub 1422 to configure a second communication interface of smart hub 1422 to receive multicast communications sent by server 130 to a multicast group address associated with a multicast group via a dedicated multicast communication channel of wireless network 1410. It should be appreciated that any of various communication frequencies may be used for communications over either the first communication channel or the second communication channel and that such communications are not limited to a specific frequency (e.g., a specific LoRa frequency) or a specific wireless standard (e.g., only LoRa frequencies or only 802.11ah frequencies). Additionally, in some implementations, lower frequencies may be used for the first communication channel as compared to frequencies of the second communication channel to facilitate longer range wireless communications via the first communication channel as compared to the second communication channel. In addition to smart hub 1422, other devices (or members) of the multicast group may include, for example, other smart hubs corresponding to other units of the multi-family residential property, as will be described in further detail below with reference to FIG. 15.

FIG. 15 is a block diagram of a system 1500 for configuring smart hubs of a multi-family residential property using dedicated unicast and multicast communication channels between the smart hubs and a server of a property management platform in accordance with embodiments of the present disclosure. For discussion purposes, system 1500 will be described with reference to various components of system 100 of FIG. 1, as described above, but system 1500 is not intended to be limited thereto. As shown in FIG. 15, server 130 of the property management platform may communicate via gateway 136 to a plurality of smart hubs 1510, 1520, 1530, and 1540. Smart hubs 1510, 1520, 1530, and 1540 may correspond to different units (e.g., residential units or apartments 510, 520, 530, 540 of building 500, as shown in FIG. 5 and described above) of the multi-family residential property.

Also, as shown in FIG. 15, smart hub 1510 may include a radio 1512 and a radio 1514, smart hub 1520 may include a radio 1522 and a radio 1524, smart hub 1530 may include a radio 1532 and a radio 1534, and smart hub 1540 may include a radio 1542 and a radio 1544. The radios of each smart hub in this example may correspond to different communication interfaces of that smart hub for receiving communications (e.g., unicast and multicast communications) from server 130 via gateway 136. For example, each of radios 1512, 1522, 1532, and 1542 may correspond to a first communication interface of the respective smart hubs 1510, 1520, 1530, and 1540. Likewise, each of radios 1514, 1524, 1534, and 1544 may correspond to a second communication interface of the respective smart hubs 1510, 1520, 1530, and 1540. While only two radios (or communication interfaces) are shown for each smart hub in FIG. 15, it should be appreciated that each smart hub may include additional radios or communication interfaces for sending and receiving communications to and from server 130, gateway 136, or other devices (e.g., smart devices installed in a corresponding unit of the multi-family residential property). Although described as multiple different interfaces or radios, it should be appreciated that these may be logical distinctions and that smart hubs 1510, 1520, 1530, and 1540 may at least partially reuse hardware, such as processors, transmit chains, receive chains, and the like, to enable both unicast and multicast communications for different addresses via different communication channels of the wireless network between smart hubs 1510, 1520, 1530, and 1540 and server 130, or with smart devices in the respective units via other wireless networks. Also, while not shown in FIG. 15, it should be appreciated that each smart hub may include one or more processors, a memory, and any of various other components (e.g., similar to smart thermostat hub 200 of FIG. 2, smart hub 300 of FIG. 3, or modular smart thermostat hub 400 of FIG. 4, as described above), as desired for a particular implementation.

In some embodiments, each radio may be configured as a uniquely addressable unicast radio by default. Therefore, to configure or reconfigure each smart hub to also support multicast communications, server 130 may use a first radio of each smart hub (e.g., radios 1512, 1522, 1532, and 1542 of the respective smart hubs 1510, 1520, 1530, and 1540) to configure a second radio of the smart hub (e.g., radios 1514, 1524, 1534, and 1544 of the respective smart hubs 1510, 1520, 1530, and 1540) to receive multicast communications. The multicast communications may include, for example, multicast messages directed by server 130 to a multicast group including smart hubs 1510, 1520, 1530, and 1540. To configure radios 1514, 1524, 1534, and 1544 of the smart hubs 1510, 1520, 1530, and 1540 to receive multicast communications directed to the multicast group, server 130 may transmit multicast configuration information to radios 1512, 1522, 1532, and 1542 of the smart hubs 1510, 1520, 1530, and 1540 via communication channels 1513, 1523, 1533, and 1543 (e.g., a dedicated unicast communication channel associated with each smart hub), respectively. For example, messages that include the multicast configuration information may be individually transmitted from server 130 to each of radios 1512, 1522, 1532, and 1542 as separate transmissions, either serially or at least partially concurrently (e.g., at least partially in parallel), via communication channels 1513, 1523, 1533, and 1543, respectively. The multicast configuration information may be included in, for example, a first command received by each smart hub from server 130 via respective radios 1512, 1522, 1532, and 1542. As shown in FIG. 15, communication channels 1513, 1523, 1533, and 1543 may be implemented as dedicated unicast communication channels between gateway 136 and the respective radios 1512, 1522, 1532, and 1542 of smart hubs 1510, 1520, 1530, and 1540. Alternatively, communication channels 1513, 1523, 1533, and 1543 may be implemented as dedicated unicast communication channels between server 130 and the respective radios 1512, 1522, 1532, and 1542 of smart hubs 1510, 1520, 1530, and 1540.

In some embodiments, the multicast configuration information sent by server 130 to each of smart hubs 1510, 1520, 1530, and 1540 may include a multicast group address and an encrypted multicast key associated with the multicast group. Each of smart hubs 1510, 1520, 1530, and 1540 may decrypt the encrypted multicast key to generate one or more unencrypted keys for the multicast group based on a root key stored in a secure storage area of the memory of that smart hub. In some implementations, the root key may be provisioned into the secure storage area of the memory by a manufacturer of the smart hub. Alternatively, the root key may be provisioned into the secure storage area by the property manager or a trusted third-party associated with the property manager. In some implementations, the secure storage area may be a secure element or hardware security module designed to store the root key and other confidential data from unauthorized access. The secure element may be implemented as, for example, a removable device (e.g., a universal integrated circuit card (UICC) or secure digital (SD) card) coupled to each smart hub or an embedded secure element chip within each smart hub. Alternatively, the root key may be provided by a third party validation service that provides encrypted root keys to smart hubs 1510, 1520, 1530, and 1540 that are decryptable based on information stored at (e.g., known to) the respective smart hubs.

In some embodiments, the multicast group address and the one or more unencrypted keys derived from the root key may be part of a multicast profile that is common to all devices in the multicast group and that is necessary for each device to receive multicast messages (or downlink frames) sent to the group by the management platform (e.g., by server 130 and/or gateway 136) via a multicast communication channel (or multicast downlink) 1515. Accordingly, each of smart hubs 1510, 1520, 1530, and 1540 may generate and store the multicast profile, including the multicast group address received from server 130 and the one or more unencrypted keys derived from the root key, for the multicast group in memory. The multicast profile may be used to configure respective radios 1514, 1524, 1534, and 1544 of smart hubs 1510, 1520, 1530, and 1540 to receive multicast messages from server 130 directed to the multicast group via the multicast communication channel 1515. The multicast profile, the root key, and a unique identifier (ID) (e.g., a Device Extended Unique Identifier (DevEUI)) associated with each of smart hubs 1510, 1520, 1530, and 1540 may be stored in a memory or database of server 130. While the multicast communication channel 1515 is shown in FIG. 15 as a single communication channel between gateway 136 and respective radios 1514, 1524, 1534, and 1544 of smart hubs 1510, 1520, 1530, and 1540, it should be appreciated that the multicast communication channel 1515 may be implemented as one or more dedicated multicast communication channels between server 130 and respective radios 1514, 1524, 1534, and 1544 of smart hubs 1510, 1520, 1530, and 1540.

In some embodiments, one or more of smart hubs 1510, 1520, 1530, and 1540 (or respective radios 1514, 1524, 1534, and 1544 thereof) may be associated with multiple multicast groups. For example, in addition to the first multicast group including smart hubs 1510, 1520, 1530, and 1540 described above, smart hubs 1510 and 1520 may be associated with a second multicast group and smart hubs 1530 and 1540 may be associated with a third multicast group. Server 130 in this example may generate and transmit second multicast configuration information to respective radios 1512 and 1522 of smart hubs 1510 and 1520 to configure respective radios 1514 and 1524 of smart hubs 1510 and 1520 to receive multicast communications directed to the second multicast group. Likewise, server 130 may generate and transmit third multicast configuration information to respective radios 1532 and 1542 of smart hubs 1530 and 1540 to configure respective radios 1534 and 1544 of smart hubs 1530 and 1540 to receive multicast communications directed to the third multicast group. In some implementations, server 130 may use separate multicast communication channels (e.g., a second multicast channel and a third multicast channel) in addition to multicast communication channel 1515 to send the multicast communications directed to the second and third multicast groups.

In some embodiments, the various multicast groups may correspond to different categories of units of the multi-family residential property. For example, the first multicast group, including smart hubs 1510, 1520, 1530, and 1540, may correspond to a first category comprising different residential units or apartments of a building (e.g., apartments 510, 520, 530, 540 of building 500 in FIG. 5, as described above) of the multi-family residential property. The second multicast group, including smart hubs 1510 and 1520, may correspond to a second category comprising occupied units of the building, and the third multicast group, including smart hubs 1530 and 1540, may correspond to a third category comprising vacant units of the multi-family residential property. In some embodiments, a separate multicast profile, including the corresponding multicast group address and multicast keys, for each multicast group associated with a particular smart hub may be stored in the memory of that smart hub. The multicast profile for each multicast group may also be stored in the memory or database of server 130 in association with the DevEUI and root key of each smart hub in the group.

It should be appreciated that the different multicast groups may correspond to any of various categories of units as desired for a particular implementations. In some implementations, the different multicast groups and categories of units may vary based on a type of each unit (e.g., an apartment vs. a designated common area), a location of each unit (e.g., the particular building in which the unit is located), and/or a residency/vacancy status of each unit (e.g., occupied vs. vacant). Thus, in a different example, smart hubs 1510, 1520, 1530, and 1540 may correspond to units that are categorized by type rather than residency/vacancy status, e.g., where smart hubs 1510 and 1520 may correspond to residential units of the multi-family residential property and smart hubs 1530 and 1540 may correspond to one or more designated common areas of the property.

Although not shown in FIG. 15, each of smart hubs 1510, 1520, 1530, and 1540 may be associated with one or more smart devices, such as a smart door lock or a smart light, installed in a corresponding unit of the multi-family residential property. In some embodiments, server 130 may transmit multicast messages including control information for controlling an operating state of the one or more smart devices associated with each smart hub in a particular multicast group. As described above, each smart hub may transmit one or more commands to control an operating state of the one or more smart devices in accordance with the control information included in the multicast message received from server 130. In some embodiments, each of smart hubs 1510, 1520, 1530, and 1540 (or a subset of the smart hubs in a particular multicast group) may receive multicast messages including the control information for the smart device(s) associated that smart hub during one or more multicast sessions between server 130 and the second communication interface of the smart hub over multicast communication channel 1515. Each multicast session may occur at a specified time as indicated by multicast session information transmitted by server 130 to each smart hub in the multicast group. For example, the multicast session information indicating a specified time for a multicast session may be transmitted to respective radios 1512, 1522, 1532, and 1542 of smart hubs 1510, 1520, 1530, and 1540. Server 130 in this example may transmit one or more multicast messages to the multicast group (e.g., to respective radios 1514, 1524, 1534, and 1544 of smart hubs 1510, 1520, 1530, and 1540) via multicast communication channel 1515 at the specified time of the multicast session.

In some embodiments, the control information transmitted to the smart devices of each multicast group may vary according to the category of units to which that group corresponds. For example, the control information transmitted to the third multicast group in the first example above (e.g., including smart hubs 1530 and 1540 corresponding to the third category of vacant units described above) may include control information for modifying or disabling access credential data stored at a smart door lock associated with each of the vacant units. In a different example, the control information may be used to control the operating state of the one or more smart devices associated with each multicast group according to an operating schedule associated with the category of units corresponding to that group (e.g., an operating schedule that controls operating settings of the smart light(s), smart thermostat(s), and/or other smart devices associated with common areas or residential units of the multi-family residential property).

In addition to configuring or reconfiguring the smart devices of a residential unit (e.g., to revoke access credentials and/or reset each device to a default operating state after a resident has moved out), the property manager may need to periodically install firmware updates to maintain the security and reliability of these devices over time. Such updates may include, for example, bug fixes, security patches, and performance improvements released by smart device manufacturers to address issues and enhance the functionality of their devices after deployment. Conventional solutions for performing firmware updates over the air (OTA) typically require sending firmware updates or commands to the smart devices in a serial manner, where the same update or command is sent to each device individually one after another. This can be very time-consuming and can reduce the amount of network bandwidth available for other communications. For example, server 130 may have to serially transmit the same firmware update to each of smart hubs 1510, 1520, 1530, and 1540 individually, thus congesting the wireless network and using network bandwidth equal to four times the size of the firmware update. As can be appreciated, such a problem becomes much worse as the number of smart hubs at the multi-family residential property grows larger. To save time and bandwidth, a property manager may use the dedicated multicast communication channel of server 130 and corresponding communication interfaces (e.g., radios 1514, 1524, 1534, and 1544) of smart hubs 1510, 1520, 1530, and 1540 to send a single multicast message including the firmware update to all of the smart hubs (e.g., as part of the same multicast group). In response to receiving the multicast message in this example, each of smart hubs 1510, 1520, 1530, and 1540 may apply the update to the firmware stored in a non-volatile memory of the smart hub. Such an example enables firmware updates to be performed in a faster manner that is associated with significantly less network congestion, thereby reducing or avoiding degradation to other network communications and improving user experience associated with smart hubs 1510, 1520, 1530, and 1540.

FIG. 16 shows an example of a GUI 1600 of a mobile application for providing a user (e.g., a resident of unit 1420 of FIG. 14) of a mobile device (e.g., user device 140 of FIG. 14) with remote access and control features for smart devices and network configuration features in accordance with embodiments of the present disclosure. GUI 1600 may be used by the resident to determine a current operating status as well as to change the operating settings of the various smart devices installed at the resident's apartment unit and connected to a short-range wireless network (e.g., a Wi-Fi network, a Bluetooth network, a Bluetooth Low Energy (BLE) network, a Zigbec network, or a Z-Wave network). In some implementations, the short-range wireless may be established by a property manager or owner of the resident's apartment unit and/or multi-family residential property. GUI 1600 may also be used by the resident to change a network configuration or settings of the wireless network.

As shown in FIG. 16, GUI 1600 includes separate control panels 1610, 1620, and 1630 corresponding to a smart thermostat, a smart lock, and a smart light (e.g., a smart thermostat coupled to smart hub 1422, smart lock 1424, and smart light 1426 of FIG. 14) installed within the resident's apartment unit, a control panel 1640 corresponding to the resident's other networked devices (e.g., IoT camera 1428 of FIG. 14 or other smart devices installed at the unit), and a control panel 1650 corresponding to network settings. Control panel 1610 allows the resident to view the smart thermostat's current temperature setting and adjust the temperature, e.g., by using control buttons to increase or decrease the temperature. Control panel 1620 allows the resident to view the lock status of the smart lock and provides a slider control to either lock or unlock the smart lock. In some implementations, control panel 1620 may also include button(s) or other interactive component(s) that allow the resident to view users who have access credentials stored at the smart lock or to retrieve a log from the smart lock. Control panel 1630 allows the resident to view the status of the smart light and provides a slider control to turn on or off the smart light.

Control panel 1640 allows the resident to view other smart devices (e.g., IoT camera 1428 of FIG. 14, a smart tv, a video doorbell, a smart assistant, etc.) associated with the apartment unit and control one or more operational settings of each smart device. In some implementations, selecting control panel 1640 (e.g., via touch input in an area of the GUI 1600 corresponding to the control panel 1640) may cause GUI 1600 to display a separate window or UI control (e.g., a pop-up window or menu) that allows the resident to select a particular smart device from a list of devices. The selection of a particular smart device from the list in some cases may open a separate mobile application specifically for the selected device, which may include its own GUI that allows the resident to change operating settings and perform other tasks related to that particular device (such as viewing a live video feed or recorded images and video captured by a smart camera, changing a channel of a smart tv, viewing video from a video doorbell, providing a voice command to a smart assistant, or the like). Alternatively, selecting a smart device from such a list may open a separate control panel or page of GUI 1600 including the controls and settings for the selected device.

Control panel 1650 allows the resident to view the smart devices connected to the wireless network associated with the apartment unit and optionally add or remove selected smart devices (or corresponding device connections) from the wireless network or otherwise configure the wireless network (e.g., by setting security credentials, wireless channels, a device limit, etc.). In some embodiments, GUI 1600 may include a control button 1612 that enables the resident to add new control panels for additional smart devices that are later installed at the apartment unit or added to the public wireless network. GUI 1600 may also include a settings button 1614 that allows the resident to access additional controls or settings (e.g., notification settings) associated with the smart devices or smart thermostat hub.

FIG. 17 shows an example of a GUI 1700 of an application for providing a property manager of a property management platform (e.g., server 130 of FIG. 14 or FIG. 15, or a client device that communicates with server 130 to perform operations described herein) with remote access and control features for smart devices, including credential management features for smart locks and device reconfiguration features for other smart devices, in accordance with embodiments of the present disclosure.

GUI 1700 may be used by the property manager, or an employee of a property management company, to determine current operating statuses as well as to change the operating states or settings of the various smart devices (e.g., the smart thermostat coupled to or controlled by smart hub 1422, smart lock 1424, smart light 1426, and IoT camera 1428 of FIG. 14) installed at one or more apartment units (e.g., multi-family residential units) or properties. As shown in FIG. 17, GUI 1700 includes control panels 1710, 1720, 1730, 1740, and 1750 corresponding to the various aspects of property management. Although five separate control panels are shown in FIG. 17, in other embodiments, less than five or more than five control panels may be included in GUI 1700, and information in one or more of the control panels shown in FIG. 17 may instead by displayed in one or more other control panels.

Control panel 1710 allows the property manager to select a property for which to view information and control elements. In some embodiments, control panel 1710 may include a dropdown list or other selectable element to enable selection of one or more properties associated with the property manager. Such a unit selection control element in control panel 1720 allows the property manager to select one or more units of the selected property for which to view status information and provide instructions for controlling aspects of smart devices or for reconfiguring smart devices or networks. In some embodiments, control panel 1720 may include arrow buttons or other selectable elements to enable selection of the one or more units of the selected property. Although referred to as unit selection, control panel 1720 may also enable selection of common areas and outdoor areas that contain smart thermostat hub(s) and other smart device(s).

In the example shown in FIG. 17, control panel 1730 allows the property manager to view a smart thermostat's current temperature setting and adjust the temperature, e.g., by using control buttons to increase or decrease the temperature. Control panel 1730 also allows the property manager to view the lock status of a smart lock and provides a slider control to either lock or unlock the smart lock. Control panel 1730 also allows the property manager to view the status of a smart light and provides a slider control to turn on or off the smart light. In some implementations, control panel 1730 may include an additional settings button that allows the property manager to access additional controls or settings, such as notification settings, scheduling settings, security settings, or the like, associated with the smart devices or smart thermostat hub in the selected unit of the selected property. Control panel 1740 allows the property manager to view the access credentials configured at a smart lock of the selected unit. In the example shown in FIG. 17, the access credentials are currently enabled: a first credential for first user (e.g., “Anna”, as represented by the character string following Anna), a second credential for a second user (e.g., “Bob”), and a third credential for a third user (e.g., “Charlie”). Control panel 1740 may also include a configure credentials button that enables the property manager to configure the access credentials for the smart lock of the selected unit as further described above, such as by adding additional access credential(s) or by deleting or otherwise invalidating existing access credential(s).

In some embodiments, control panel 1740 may include a reset button 1745 that allows the property manager to reconfigure (e.g., wipe) the access credentials from the memory of one or more smart devices (e.g., a smart door lock) in the selected unit. Selecting reset button 1745 may also allow the property manager to reset or re-initialize settings of the smart device(s) installed at the unit, such as smart door locks, the thermostat of a smart thermostat hub, smart lights that are provided by the property manager, or other smart devices that are provided and maintained by the property manager and that remain at the unit after a current resident has moved out. Resetting or re-initializing the settings may wipe any settings that were set by the resident, any user IDs or access information associated with the resident, any information associated with devices of the resident that were connected to a wireless network and/or a smart thermostat hub. For example, to “wipe” the smart devices and reconfigure the unit for a new resident, the property manager may use the reset button 1745 in control panel 1740 to cause a server (e.g., server 130 of FIG. 14) of the property management platform to transmit instructions via a long-range wireless network (e.g., wireless network 1410 of FIG. 14, as described above) to the smart thermostat hub in the unit for distribution to the smart devices to cause the smart devices to delete any stored credential and other relevant information or otherwise return to an initial or default configuration ready for use by a new resident, e.g., via an application executed at a user device (e.g., user device 140 of FIG. 14).

In some embodiments, the reset instructions may be included in a multicast message transmitted during a multicast session to multiple smart hubs in a multicast group corresponding to different units of the property, as described above with respect to FIG. 15. For example, the property manager may use the unit selection control element in control panel 1720 to select multiple residential units (or apartments) corresponding to an apartment building (e.g., apartments 510, 520, 530, and 540 of building 500 of FIG. 5, as described above). Accordingly, selecting reset button 1745 in control panel 1740 may cause the server of the property management platform to generate and transmit a multicast message including the reset instructions to smart hubs (e.g., smart hubs 512, 522, 532, and 542) corresponding to the selected apartment units. The server may also send additional multicast messages to the multicast group to control the operating states or settings of the various smart devices associated with the smart hubs of the respective units based on the input received from the property manager via GUI 1700. Such multicast messages may include commands for controlling or configuring either the one or more smart devices associated with a smart hub or the smart hub itself. For example, a multicast message sent by the server to the multicast group during a multicast session may include control information that each smart hub may use to control an operating state of the one or more smart devices (e.g., a lock state of a smart door lock) associated with that smart hub. Additionally or alternatively, the server may broadcast a multicast message to the multicast group that includes information for updating a configuration or firmware of each smart hub.

In some implementations, GUI 1700 may include a separate control panel for the property manager to define various multicast groups by selecting different sets of smart hubs for each group. As described above with reference to FIG. 15, the different multicast groups and corresponding sets of smart hubs may represent different categories of units in the multi-family residential property. For example, a first multicast group may include a first category of smart hubs corresponding to different residential units or apartments of a building (e.g., apartments 510, 520, 530, 540 of building 500 in FIG. 5, as described above) of the multi-family residential property, a second multicast group may include a second category of the smart hubs from the first multicast group that correspond to occupied units of the building, and a third multicast group may include a third category of the smart hubs from the first multicast group that correspond to vacant units of the building. As described above, the multicast messages sent to each multicast group may include control information for appropriately controlling an operating state of the one or more smart devices associated with each smart hub. For example, the multicast messages sent to the smart hubs in the third multicast group (corresponding to vacant units of the building) may include control information for modifying or disabling access credential data stored at a respective smart door lock associated with each smart hub in the group.

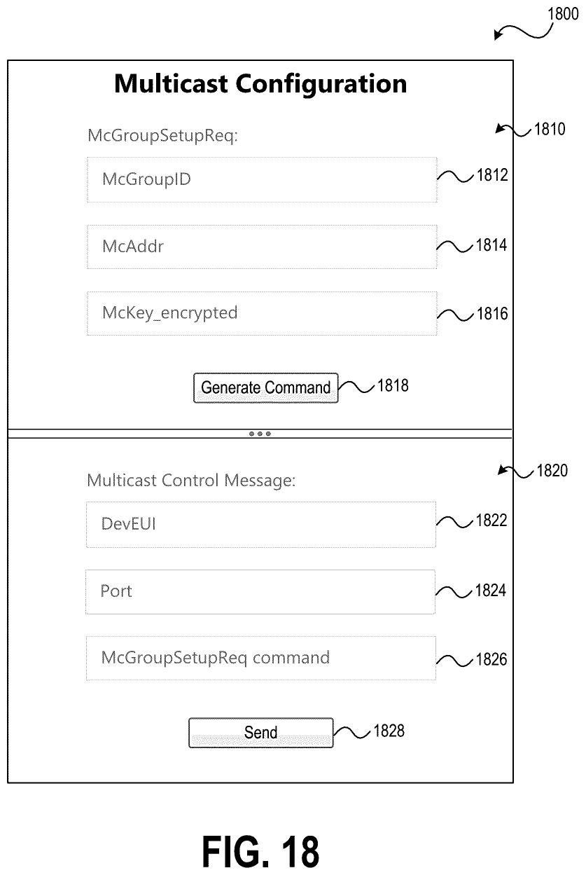

In some embodiments, the multicast group and/or multicast session for each group may be configured by the property manager via a separate dashboard accessible by selecting a button 1755 in control panel 1750 of GUI 1700. An example of such a multicast configuration dashboard is shown in FIG. 18.

FIG. 18 is an exemplary GUI 1800 of a multicast configuration dashboard for configuring a multicast group including smart hubs of a multi-family residential property via an application of a property management platform in accordance with embodiments of the present disclosure. GUI 1800 may be used by the property manager in the example of FIG. 17 described above to configure the multicast group and session information. For discussion purposes, GUI 1800 will be described in the context of LoRaWAN and multicast commands according to the LoRaWAN Remote Multicast Setup Specification (“LoRaWAN multicast specification”) published in 2022 by LoRa Alliance, Inc. However, it should be appreciated that embodiments of the present disclosure are not intended to be limited thereto and that the disclosed systems and techniques for remote management and configuration of smart devices with multicast support may be applied to any of various wireless technologies and networks (e.g., another type of LPWAN, a cellular network, or other long-range wireless network).

As shown in FIG. 18, GUI 1800 may include a control panel 1810 and a control panel 1820. Control panel 1810 may be used to set up a multicast group. Control panel 1810 may include text fields 1812, 1814 and 1816 that the property manager may use to specify multicast configuration information used to configure each smart hub to be a member of the multicast group and to receive multicast communications directed to the multicast group. The multicast configuration information specified using fields 1812, 1814 and 1816 may include different parameters of the multicast group. Field 1812 may be used to specify a multicast group ID (“McGroupID”). As described above, each smart hub or other end device may be associated with multiple multicast groups (e.g., up to four multicast groups under the LoRaWAN multicast specification). The multicast group ID may be, for example, a number (e.g., an integer between 0 and 3) that the property manager chooses to assign to a particular multicast group. Field 1814 may be used to specify a multicast group address (“McAddr”) for a corresponding multicast group. Field 1816 may be used to specify an encrypted multicast group key (“McKey_encrypted”) for the multicast group. In some implementations, the encrypted multicast group key may be generated based, at least in part, on a device-specific root key stored in a secure storage area of a smart hub to be added to the multicast group. In some implementations, one or more of fields 1812, 1814, and 1816 may include a drop-down menu to provide available options to be entered or may automatically generate a value (e.g., the multicast group key) based on input from a user. After updating fields 1812, 1814, and 1816 with appropriate parameter values for the multicast group via GUI 1800, the property manager may generate a multicast group setup request (“McGroupSetupReq”) command by selecting a button 1818 in control panel 1810. The multicast command may be generated with the multicast configuration information in a format that includes different bit fields corresponding to the multicast group parameters (McGroupID, McAddr, and McKey_encrypted) specified in fields 1812, 1814, and 1816, respectively. The generated multicast command, including the multicast configuration information, may then be sent to each smart hub selected for the multicast group.

In some implementations, the multicast group setup command may be included as a payload of a multicast control message that will be sent to each selected smart hub. In addition to the multicast group setup command, the multicast control message may include additional multicast configuration information for each smart hub. The property manager may use control panel 1820 to specify the additional multicast configuration information for configuring the selected smart hubs of the multicast group via fields 1822 and 1824. For each smart hub, the property manager may use field 1822 to specify a corresponding DevEUI of the smart hub and use field 1824 to specify a port number (e.g., a default port value) for the smart hub to use when communicating with the server. For example, the smart hub may send the server an “McGroupSetupAns” acknowledgement message on the specified port to acknowledge reception of the multicast control message including the multicast configuration information. As shown in FIG. 18, control panel 1820 may also include a field 1826 for specifying the payload of the multicast control message (e.g., the multicast group setup request command generated via control panel 1810). In some implementations, field 1826 may be automatically populated with the multicast group setup request (McGroupSetupReq) command generated via control panel 1810. The property manager may select a button 1828 in control panel 1820 to have the server send the multicast control message to a smart hub corresponding to the DevEUI specified in field 1822. To send the multicast control message to each remaining smart hub selected for the multicast group, the property manager may update the DevEUI in field 1822 accordingly and select button 1828.

The multicast control message including the multicast configuration information may be sent by the server of the property management platform via a dedicated unicast channel to a first communication interface of each smart hub (e.g., to respective radios 1512, 1522, 1532, and 1542 of smart hubs 1510, 1520, 1530, and 1540 of FIG. 15, as described above). The multicast configuration information received by each smart hub may then be used to configure a second communication interface of that smart hub (e.g., respective radios 1514, 1524, 1534, and 1544 of smart hubs 1510, 1520, 1530, and 1540 of FIG. 15) to receive multicast communications directed to the corresponding multicast group. It should be appreciated that GUI 1800 may also be used by the property manager to set up additional multicast groups (with different multicast group IDs and addresses) for different sets of smart hubs as desired for a particular implementation.

In some embodiments, control panel 1820 of GUI 1800 may be used to send a second multicast control message to the respective first communication interfaces of the smart hubs in a multicast group. The second multicast control message may include multicast session information that specifies a time period for the multicast group to receive multicast messages from the server during a multicast session. Upon receiving the second multicast control message, each smart hub of the multicast group in this example may switch its second communication interface from a first communication mode (e.g., a low-power, standby or sleep mode to conserve power) to a second communication mode (e.g., an activation mode to wake up and listen for multicast messages) at the specified time period of the multicast session.

Although not shown in FIG. 18, it should be appreciated GUI 1800 may include an additional control panel for sending multicast messages to each multicast group during a corresponding multicast session. The additional control panel may include, for example, a group ID field for specifying a multicast group ID (similar to field 1812) of a particular multicast group and a payload field (similar to field 1826) for specifying a payload of the multicast message to be sent to each smart hub in the group. The payload of the multicast message may include, for example, control information for controlling an operating state of one or more smart devices associated with each smart hub in the group. For example, the payload of a multicast message sent to smart hubs in a multicast group corresponding to vacant units of an apartment building may include control information for modifying or disabling access credential data stored at a respective smart door lock associated with each smart hub in the group.

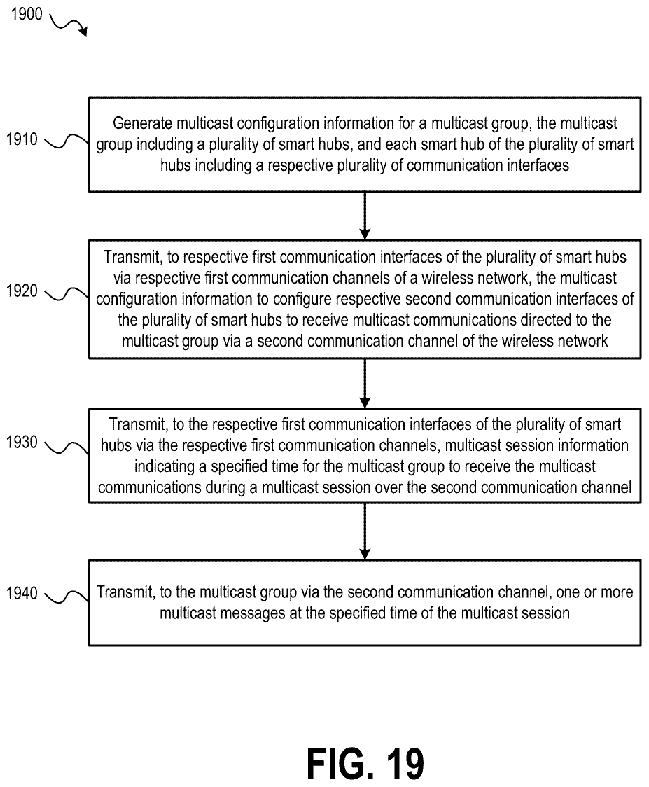

FIG. 19 is a flowchart of an exemplary process 1900 for configuring smart hubs of a property to support unicast and multicast communications over dedicated unicast and multicast communication channels of a wireless network in accordance with embodiments of the present disclosure. Process 1900 may be performed by, for example, a server of a property management platform, such as server 130 as described above with respect to FIGS. 1, 5-7, 14, and 15.

Process begins at block 1910, which includes generating multicast configuration information for a multicast group including a plurality of smart hubs. The multicast group may include, for example, a plurality of smart hubs corresponding to different units of a multi-family residential property, a commercial property, or an industrial property. Each smart hub of the plurality of smart hubs may include a respective plurality of communication interfaces.

At block 1920, the multicast configuration information may be transmitted to respective first communication interfaces of the plurality of smart hubs via respective first communication channels of a wireless network (e.g., a long-range wireless network, as described above). The multicast configuration information may be used to configure respective second communication interfaces of the plurality of smart hubs to receive multicast communications directed to the multicast group via a second communication channel of the wireless network.

At block 1930, multicast session information may be transmitted to the respective first communication interfaces of the plurality of smart hubs via the respective first communication channels. The multicast session information may indicate a specified time for the multicast group to receive the multicast communications during a multicast session over the second communication channel.

Process 1900 may then proceed to block 1940, which includes transmitting, to the multicast group via the second communication channel, one or more multicast messages at the specified time of the multicast session.

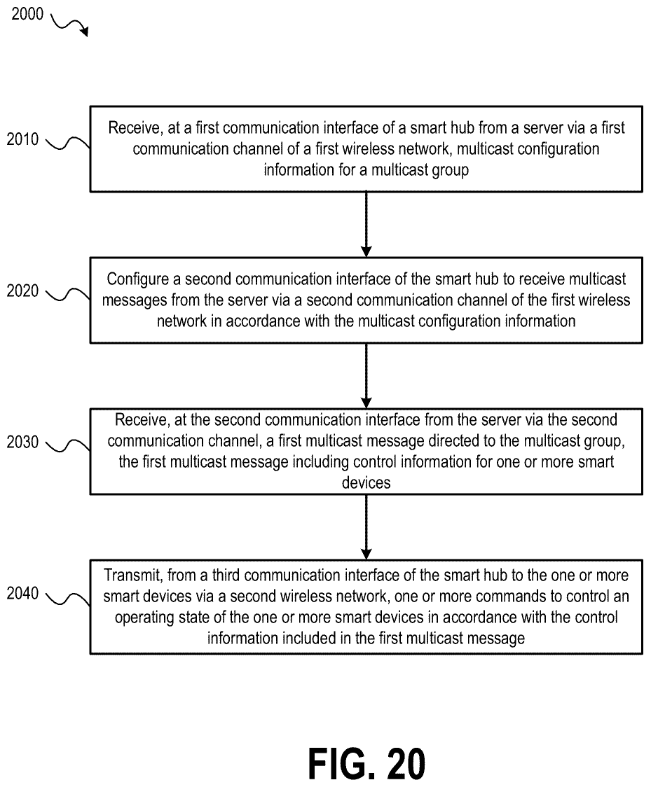

FIG. 20 is a flowchart of an exemplary process 2000 for controlling smart devices in a unit of a property using a smart hub with support for unicast and multicast communications over dedicated unicast and multicast communication channels of a wireless network in accordance with embodiments of the present disclosure. Process 2000 may be performed by, for example, one or more processors of a smart hub, such as smart hub 110 of FIG. 1, smart thermostat hub 200 of FIG. 2, modular smart thermostat hub 400 of FIG. 4, smart hub 1422 of FIG. 14, or any of smart hubs 1510, 1520, 1530, and 1540 of FIG. 15, as described above.

As shown in FIG. 20, process 2000 begins at block 2010, which includes receiving, at a first communication interface of the smart hub from a server via a first communication channel of a first wireless network, multicast configuration information for a multicast group. The multicast group may be associated with any of the properties described herein, such as an industrial property, a commercial property, a residential property, or a multi-family residential property. The first wireless network may be, for example, a long-range wireless network, such as a cellular network or LPWAN.

At block 2020, the multicast configuration information may be used to configure a second communication interface of the smart hub to receive multicast messages from the server. The multicast messages may be received from the server via a second communication channel of the first wireless network. Accordingly, the first communication interface may serve as a dedicated unicast communication interface for receiving unicast communications from the server via the first communication channel (e.g., a dedicated unicast communication channel). The unicast communications from the server may be directed to a unique unicast address associated with the first communication interface. The second communication interface may serve as a dedicated multicast communication interface for receiving multicast communications from the server via the second communication channel (e.g., a dedicated multicast communication channel). The multicast communications from the server may be directed to a multicast group address associated with the second communication interface and other devices in a corresponding multicast group.

Process 2000 may then proceed to block 2030, which includes receiving, at the second communication interface of the smart hub from the server via the second communication channel, a first multicast message directed to the multicast group. The first multicast message may include, for example, control information for one or more smart devices installed in a unit of the multi-family residential property.

In response to receiving the first multicast message, one or more commands may be transmitted at block 2040 from a third communication interface of the smart hub to the one or more smart devices via a second wireless network. The one or more commands may be used to control an operating state of the one or more smart devices in accordance with the control information included in the first multicast message. The second wireless network may be a short-range wireless network, such as a Bluetooth network, a Z-Wave network, a Zigbee network, a Thread-compliant network, a Matter-compliant network, or a Wi-Fi network, through which the smart device(s) may be communicatively coupled to the third communication interface.

In a first aspect, a system for controlling smart devices, the system comprises: a first communication interface to communicate with a server via a first communication channel of a first wireless network; a second communication interface to communicate with the server via a second communication channel of the first wireless network; a third communication interface to communicate with one or more smart devices via a second wireless network; a processor; and a memory coupled to the processor, the memory storing instructions, which, when executed by the processor, cause the processor to execute operations to: receive, from the server via the first communication interface, multicast configuration information for a multicast group; configure the second communication interface to receive multicast messages from the server via the second communication channel in accordance with the multicast configuration information; receive, from the server via the second communication interface, a first multicast message directed to the multicast group, the first multicast message including control information for the one or more smart devices; and transmit, to the one or more smart devices via the third communication interface, one or more commands to control an operating state of the one or more smart devices in accordance with the control information included in the first multicast message.

In a second aspect, alone or in combination with one or more of the above aspects, the first wireless network is a long-range wireless network, wherein the second wireless network is a short-range wireless network, wherein the server is associated with a property management platform of a commercial property, and wherein the one or more smart devices are associated with a particular unit of the commercial property.

In a third aspect, alone or in combination with one or more of the above aspects, the long-range wireless network is at least one of a cellular network or a low-power wide area network (LPWAN), and wherein the short-range wireless network is at least one of a Wi-Fi network, a Bluetooth network, a Bluetooth Low Energy (BLE) network, a Zigbee network, or a Z-Wave network.

In a fourth aspect, alone or in combination with one or more of the above aspects, the long-range wireless network is a low-power wide area network (LPWAN), wherein first communication channel is dedicated to unicast communications between the server and the first communication interface over the LPWAN, and wherein the second communication channel is dedicated to multicast communications between the server and the second communication interface over the LPWAN.

In a fifth aspect, alone or in combination with one or more of the above aspects, the multicast configuration information is included in a first multicast control message received from the server via the first communication interface to configure the second communication interface to receive the multicast messages from the server over the second communication channel of the LPWAN during one or more multicast sessions, and wherein the first multicast message is received during a first multicast session between the server and the second communication interface over the second communication channel.

In a sixth aspect, alone or in combination with one or more of the above aspects, the operations further comprise operations to: receive, from the server via the first communication interface, a second multicast control message including multicast session information that specifies a time period for the multicast group to receive the multicast messages from the server during the first multicast session; and switching the second communication interface from a first communication mode to a second communication mode at the specified time period of the first multicast session.

In a seventh aspect, alone or in combination with one or more of the above aspects, the multicast configuration information includes a multicast group address and an encrypted multicast key associated with the multicast group, and wherein the memory includes a secure storage area for storing a root key for the multicast group.

In an eighth aspect, alone or in combination with one or more of the above aspects, the operations to configure the second communication interface comprise operations to: decrypt the encrypted multicast key to generate one or more unencrypted keys for the multicast group based on the root key stored in the secure storage area of the memory; generate a multicast profile including the multicast group address and the one or more unencrypted keys for the multicast group; and configure the second communication interface to receive the multicast messages from the server for the multicast group, based on the multicast profile.

In a ninth aspect, alone or in combination with one or more of the above aspects, the memory includes non-volatile memory, wherein the non-volatile memory is used to store firmware executable by the processor, and wherein the operations further comprise operations to: receive, from the server via the second communication interface during a second multicast session, a second multicast message including an update for the firmware stored in the non-volatile memory; and apply the update to the firmware stored in the non-volatile memory in response to the second multicast message.

In a tenth aspect, alone or in combination with one or more of the above aspects, server is associated with a property management platform of a multi-family residential property, wherein the one or more smart devices are associated with a unit of the multi-family residential property, wherein the one or more smart devices include a smart lock installed within the unit, and wherein the one or more commands include a command to change the operating state of the smart lock from an unlocked state to a locked state.

In an eleventh aspect, alone or in combination with one or more of the above aspects, a system comprises: a processor; and a memory coupled to the processor, the memory storing instructions, which, when executed by the processor, cause the processor to execute operations to: generate multicast configuration information for a multicast group, the multicast group including a plurality of smart hubs, and each smart hub of the plurality of smart hubs including a plurality of communication interfaces; transmit, to respective first communication interfaces of the plurality of smart hubs via respective first communication channels of a wireless network, the multicast configuration information to configure respective second communication interfaces of the plurality of smart hubs to receive multicast communications directed to the multicast group via a second communication channel of the wireless network; transmit, to the respective first communication interfaces of the plurality of smart hubs via the respective first communication channels, multicast session information indicating a specified time for the multicast group to receive the multicast communications during a multicast session over the second communication channel; and transmit, to the multicast group via the second communication channel, one or more multicast messages at the specified time of the multicast session.

In a twelfth aspect, alone or in combination with one or more of the above aspects, the one or more multicast messages include a first multicast message, and wherein the first multicast message includes first control information for controlling an operating state of one or more smart devices associated with the plurality of smart hubs in the multicast group.

In a thirteenth aspect, alone or in combination with one or more of the above aspects, the one or more multicast messages further include a second multicast message, and wherein the second multicast message includes a firmware update for the one or more smart devices associated with the plurality of smart hubs in the multicast group.

In a fourteenth aspect, alone or in combination with one or more of the above aspects, the plurality of smart hubs correspond to different units of a multi-family residential property, wherein the multicast group is a first multicast group of a plurality of multicast groups associated with the multi-family residential property, wherein the first multicast group includes a first set of the smart hubs corresponding to a first category of units of the multi-family residential property, and wherein the operations further comprise operations to: generate second multicast configuration information for a second multicast group including a second set of the smart hubs corresponding to a second category of units of the multi-family residential property; transmit, to the respective first communication interfaces of the second set via the respective first communication channels of the second set, the second multicast configuration information to configure the respective second communication interfaces of the second set to receive multicast communications directed to the second multicast group via a third communication channel of the wireless network; transmit, to the respective first communication interfaces of the second set via the respective first communication channels, second multicast session information to initiate a second multicast session for the second multicast group; and transmit, to the second multicast group via the third communication channel during the second multicast session, one or more second multicast messages.

In a fifteenth aspect, alone or in combination with one or more of the above aspects, the first category of units corresponds to occupied units of the multi-family residential property, and wherein the second category of units corresponds to vacant units of the multi-family residential property.

In a sixteenth aspect, alone or in combination with one or more of the above aspects, the one or more smart devices include a smart door lock associated with each unit of the multi-family residential property, and wherein the one or more second multicast messages transmitted to the second multicast group include second control information for modifying access credential data stored at the smart door lock associated with each of the vacant units.

In a seventh aspect, alone or in combination with one or more of the above aspects, the first category of units corresponds to residential units of the multi-family residential property, and wherein the second category of units corresponds to at least one common area of the multi-family residential property.

In an eighteenth aspect, alone or in combination with one or more of the above aspects, the one or more smart devices include a smart light associated with each unit of the multi-family residential property, and wherein the one or more second multicast messages transmitted to the second multicast group include second control information for controlling an operating state of the smart light according to an operating schedule associated with the common area.

In a second aspect, alone or in combination with one or more of the above aspects, a method for configuring smart devices includes: generating, by a server, multicast configuration information for a multicast group, the multicast group including a plurality of smart hubs, and each smart hub of the plurality of smart hubs including a plurality of communication interfaces; transmitting, by the server to respective first communication interfaces of the plurality of smart hubs via respective first communication channels of a wireless network, the multicast configuration information to configure respective second communication interfaces of the plurality of smart hubs to receive multicast communications directed to the multicast group via a second communication channel of the wireless network; transmitting, by the server to the respective first communication interfaces of the plurality of smart hubs via the respective first communication channels, multicast session information indicating a specified time for the multicast group to receive the multicast communications during a multicast session over the second communication channel; and transmitting, by the server to the multicast group via the second communication channel, one or more multicast messages at the specified time of the multicast session.

In a twentieth aspect, alone or in combination with one or more of the above aspects, a method includes: receiving, at a first communication interface of a smart hub from a server via a first communication channel of a first wireless network, multicast configuration information for a multicast group; configuring, by the smart hub, a second communication interface of the smart hub to receive multicast messages from the server via a second communication channel of the first wireless network in accordance with the multicast configuration information; receiving, at the second communication interface from the server via the second communication channel, a first multicast message directed to the multicast group, the first multicast message including control information for one or more smart devices; and transmitting, from a third communication interface of the smart hub to the one or more smart devices via a second wireless network, one or more commands to control an operating state of the one or more smart devices in accordance with the control information included in the first multicast message.

Although the embodiments of the present disclosure and their advantages have been described in detail, it should be understood that various changes, substitutions and alterations can be made herein without departing from the spirit and scope of the disclosure as defined by the appended claims. It should be noted that although the descriptions provided above with respect to FIGS. 1-20 have been described with reference to multi-family residential properties, embodiments of the present disclosure may be readily applied to other types of properties, such as commercial properties (e.g., office spaces, warehouses, storage units, malls, and the like). Accordingly, it is to be understood that embodiments of the present disclosure are not limited to use with multi-family residential properties. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for controlling smart devices, the system comprising:
a first communication interface to communicate with a server via a first communication channel of a first wireless network;
a second communication interface to communicate with the server via a second communication channel of the first wireless network;
a third communication interface to communicate with one or more smart devices via a second wireless network;
a processor; and
a memory coupled to the processor, the memory storing instructions, which, when executed by the processor, cause the processor to execute operations to:
receive, from the server via the first communication interface, multicast configuration information for a multicast group;
configure the second communication interface to receive multicast messages from the server via the second communication channel in accordance with the multicast configuration information;
receive, from the server via the second communication interface, a first multicast message directed to the multicast group, the first multicast message including control information for the one or more smart devices; and
transmit, to the one or more smart devices via the third communication interface, one or more commands to control an operating state of the one or more smart devices in accordance with the control information included in the first multicast message.

2. The system of claim 1, wherein the first wireless network is a long-range wireless network, wherein the second wireless network is a short-range wireless network, wherein the server is associated with a property management platform of a commercial property, and wherein the one or more smart devices are associated with a particular unit of the commercial property.

3. The system of claim 2, wherein the long-range wireless network is at least one of a cellular network or a low-power wide area network (LPWAN), and wherein the short-range wireless network is at least one of a Wi-Fi network, a Bluetooth network, a Bluetooth Low Energy (BLE) network, a Zigbee network, or a Z-Wave network.

4. The system of claim 2, wherein the long-range wireless network is a low-power wide area network (LPWAN), wherein first communication channel is dedicated to unicast communications between the server and the first communication interface over the LPWAN, and wherein the second communication channel is dedicated to multicast communications between the server and the second communication interface over the LPWAN.

5. The system of claim 4, wherein the multicast configuration information is included in a first multicast control message received from the server via the first communication interface to configure the second communication interface to receive the multicast messages from the server over the second communication channel of the LPWAN during one or more multicast sessions, and wherein the first multicast message is received during a first multicast session between the server and the second communication interface over the second communication channel.

6. The system of claim 5, wherein the operations further comprise operations to:
receive, from the server via the first communication interface, a second multicast control message including multicast session information that specifies a time period for the multicast group to receive the multicast messages from the server during the first multicast session; and
switching the second communication interface from a first communication mode to a second communication mode at the specified time period of the first multicast session.

7. The system of claim 5, wherein the multicast configuration information includes a multicast group address and an encrypted multicast key associated with the multicast group, and wherein the memory includes a secure storage area for storing a root key for the multicast group.

8. The system of claim 7, wherein the operations to configure the second communication interface comprise operations to:
decrypt the encrypted multicast key to generate one or more unencrypted keys for the multicast group based on the root key stored in the secure storage area of the memory;
generate a multicast profile including the multicast group address and the one or more unencrypted keys for the multicast group; and
configure the second communication interface to receive the multicast messages from the server for the multicast group, based on the multicast profile.

9. The system of claim 1, wherein the memory includes non-volatile memory, wherein the non-volatile memory is used to store firmware executable by the processor, and wherein the operations further comprise operations to:
receive, from the server via the second communication interface during a second multicast session, a second multicast message including an update for the firmware stored in the non-volatile memory; and
apply the update to the firmware stored in the non-volatile memory in response to the second multicast message.

10. The system of claim 1, wherein the server is associated with a property management platform of a multi-family residential property, wherein the one or more smart devices are associated with a unit of the multi-family residential property, wherein the one or more smart devices include a smart lock installed within the unit, and wherein the one or more commands include a command to change the operating state of the smart lock from an unlocked state to a locked state.

11. A system comprising:
a processor; and
a memory coupled to the processor, the memory storing instructions, which, when executed by the processor, cause the processor to execute operations to:
generate multicast configuration information for a multicast group, the multicast group including a plurality of smart hubs, and each smart hub of the plurality of smart hubs including a plurality of communication interfaces;
transmit, to respective first communication interfaces of the plurality of smart hubs via respective first communication channels of a wireless network, the multicast configuration information to configure respective second communication interfaces of the plurality of smart hubs to receive multicast communications directed to the multicast group via a second communication channel of the wireless network;
transmit, to the respective first communication interfaces of the plurality of smart hubs via the respective first communication channels, multicast session information indicating a specified time for the multicast group to receive the multicast communications during a multicast session over the second communication channel; and
transmit, to the multicast group via the second communication channel, one or more multicast messages at the specified time of the multicast session.

12. The system of claim 11, wherein the one or more multicast messages include a first multicast message, and wherein the first multicast message includes first control information for controlling an operating state of one or more smart devices associated with the plurality of smart hubs in the multicast group.

13. The system of claim 12, wherein the one or more multicast messages further include a second multicast message, and wherein the second multicast message includes a firmware update for the one or more smart devices associated with the plurality of smart hubs in the multicast group.

14. The system of claim 11, wherein the plurality of smart hubs correspond to different units of a multi-family residential property, wherein the multicast group is a first multicast group of a plurality of multicast groups associated with the multi-family residential property, wherein the first multicast group includes a first set of the smart hubs corresponding to a first category of units of the multi-family residential property, and wherein the operations further comprise operations to:
generate second multicast configuration information for a second multicast group including a second set of the smart hubs corresponding to a second category of units of the multi-family residential property;
transmit, to the respective first communication interfaces of the second set via the respective first communication channels of the second set, the second multicast configuration information to configure the respective second communication interfaces of the second set to receive multicast communications directed to the second multicast group via a third communication channel of the wireless network;
transmit, to the respective first communication interfaces of the second set via the respective first communication channels, second multicast session information to initiate a second multicast session for the second multicast group; and
transmit, to the second multicast group via the third communication channel during the second multicast session, one or more second multicast messages.

15. The system of claim 14, wherein the first category of units corresponds to occupied units of the multi-family residential property, and wherein the second category of units corresponds to vacant units of the multi-family residential property.

16. The system of claim 15, wherein the one or more smart devices include a smart door lock associated with each unit of the multi-family residential property, and wherein the one or more second multicast messages transmitted to the second multicast group include second control information for modifying access credential data stored at the smart door lock associated with each of the vacant units.

17. The system of claim 14, wherein the first category of units corresponds to residential units of the multi-family residential property, and wherein the second category of units corresponds to at least one common area of the multi-family residential property.

18. The system of claim 17, wherein the one or more smart devices include a smart light associated with each unit of the multi-family residential property, and wherein the one or more second multicast messages transmitted to the second multicast group include second control information for controlling an operating state of the smart light according to an operating schedule associated with the common area.

19. A method for configuring smart devices, the method comprising:
generating, by a server, multicast configuration information for a multicast group, the multicast group including a plurality of smart hubs, and each smart hub of the plurality of smart hubs including a plurality of communication interfaces;
transmitting, by the server to respective first communication interfaces of the plurality of smart hubs via respective first communication channels of a wireless network, the multicast configuration information to configure respective second communication interfaces of the plurality of smart hubs to receive multicast communications directed to the multicast group via a second communication channel of the wireless network;
transmitting, by the server to the respective first communication interfaces of the plurality of smart hubs via the respective first communication channels, multicast session information indicating a specified time for the multicast group to receive the multicast communications during a multicast session over the second communication channel; and
transmitting, by the server to the multicast group via the second communication channel, one or more multicast messages at the specified time of the multicast session.

20. A method comprising:
receiving, at a first communication interface of a smart hub from a server via a first communication channel of a first wireless network, multicast configuration information for a multicast group;
configuring, by the smart hub, a second communication interface of the smart hub to receive multicast messages from the server via a second communication channel of the first wireless network in accordance with the multicast configuration information;
receiving, at the second communication interface from the server via the second communication channel, a first multicast message directed to the multicast group, the first multicast message including control information for one or more smart devices; and
transmitting, from a third communication interface of the smart hub to the one or more smart devices via a second wireless network, one or more commands to control an operating state of the one or more smart devices in accordance with the control information included in the first multicast message.
